(19) United States
(12) Patent Application Publication
(10) Pub. No.: US 2025/0312788 A1
(43) Pub. Date: Oct. 9, 2025

(54) DEVICES, SYSTEMS AND METHODS FOR BIOLOGICAL ANALYSIS

(71) Applicant: MESA BIOTECH LLC, Carlsbad, CA (US)

(72) Inventors: Donald THOMAS, Tomball, TX (US); Conrad LINDBERG, Fallbrook, CA (US); Victor SANCHEZ, Carlsbad, CA (US); Victor MONTIJO, San Diego, CA (US); Thomas D. FORD, San Diego, CA (US)

(21) Appl. No.: 19/197,820

(22) Filed: May 2, 2025

Related U.S. Application Data
(63) Continuation of application No. PCT/US2023/078548, filed on Nov. 2, 2023.
(60) Provisional application No. 63/382,342, filed on Nov. 4, 2022.
(60) Provisional application No. 63/480,730, filed on Jan. 20, 2023.

(51) Int. Cl. B01L 3/00; B01L 7/00

(52) U.S. Cl. CPC B01L 3/502715; B01L 7/52; B01L 2200/025; B01L 2200/0689; B01L 2200/16; B01L 2300/0816; B01L 2300/1833

(57) ABSTRACT

Systems are described that provide thermal rates of change occurring in fluidic compartments, such as reaction chambers of a fluidic device, so as to achieve significantly reduced overall reaction times. Moreover, various biological analysis systems enhance temperature uniformity occurring within a reaction chamber that is subject to external thermal exchange to control a temperature therein. To increase thermal rates of change and/or enhance temperature uniformity, various embodiments of the present disclosure rely on one or more thermally insulative portions of the device surrounding chambers in which thermal cycling reactions and/or other change in temperature occurs. Providing fluidic devices with relatively fast reaction rates and thermal uniformity can both reduce the overall time for such reactions and enhance accuracy of results.

### CROSS REFERENCE TO RELATED APPLICATIONS

This application is a continuation application of International Patent Application No. PCT/US2023/078548, filed Nov. 2, 2023, which application claims benefit of U.S. Provisional Application No. 63/382,342 filed Nov. 4, 2022, and of U.S. Provisional Application No. 63/480,730 filed Jan. 20, 2023. The entire contents of the aforementioned applications are incorporated by reference herein.

### INTRODUCTION

The ability to provide fast and accurate biological analysis assays, such as for detection of target analyte, continues to be of importance in the fields of diagnostic and individualized healthcare. Moreover, biological analysis assays that rely on relatively small sample sizes is of interest. So-called point-of-care testing, which can be implemented on-site of sample collection without the need to transmit samples for processing at remote sites, also is desirable so as to enable providing relatively fast results using small sample sizes.

A variety of fluidic devices have been developed that permit a biological sample to be introduced to the device and flowed in a controlled manner through one or more reaction chambers to achieve a final detectable result. Such fluidic devices may have various chambers and flow structures on the order of microscale or less volume. In the field of biological analysis assays, such fluidic devices may be in the form of so-called “lab-on-a-chip” or “micro total analysis systems (μTAS)”. In some cases, the fluidic devices are used in conjunction with one or more external instruments to accomplish fluid movement, temperature control (i.e., heating and/or cooling) and detection (e.g., through optical sensing).

Approaches that have been implemented with such platforms include the use of a stationary system with cycling temperature or the use of a flow system with three zones at different temperatures. Stationary systems cycle the temperature of the chamber in order to modify the temperature of the PCR solution. They do not require a pumping system or other means to move the sample during PCR. The flow-through systems typically have zones at three constant temperatures, with the sample being transferred (moving) between the temperature zones. This type of PCR system is faster than the first one but utilizes and external pressure mechanism to move the sample around. The ability to utilize reduced sample volume and achieve relatively rapid results is an advantage of both approaches. Some existing architectures in which the fluidic device and various temperature control and sensors along with fluid mechanics are integrated may not make it economical to dispose of the device to avoid cross-contamination after performing only a single test. Moreover, some of the materials used to fabricate fluidic devices, such as silicon, and the fabrication processes used can lead to a relatively high unit price. Furthermore, as a result of small chamber volumes (e.g., on the scale of microliters or less), some effects can pose issues for PCR reactions, including, for example, nonspecific adsorption of biological samples, inhibition, sample evaporation, and/or formation of gas bubbles. Hybrid devices have also been developed that integrate stationary chamber and continuous flow PCR in an attempt to perform efficient temperature cycling of the flow-through microchannel PCR chip while the flexibility of varying the cycle number and the number of temperature zones in the stationary chamber PCR chip. However, such devices still pose issues related to sample inhibition, adsorption, and bubble formation, among others.

Other considerations for such fluidic devices include the desire to make them relatively low-cost, ensure accuracy of the overall workflow, including reliable flow of sample through the device, and ensure accuracy of the ultimate results.

Further, providing instruments that enable a relatively simplified and expedient workflow to receive and provide power, temperature control, fluidics control, and optics for detection of results of assays occurring in such fluidic devices is desirable. Some existing instrumentation may not be well-suited to perform different types of assays requiring differing parameters relating to fluidic and temperature control. For example, some instrumentation may only be programmed to run one or a relatively small number of assays based on preprogrammed parameters relating to the timing of the various controls, or relative complex reprogramming or firmware and software updates may be needed to expand assay capabilities.

In addition, some instruments, while providing a relative hands-off workflow to perform the various fluidics flow and temperature control for multi-stage assays, may nevertheless rely on user-based detection, such as visual observation, including for example visual observation of a colorimetric pattern developed on a lateral flow substrate, such as a line, dots, plus sign, or minus sign. Such user interactions can increase the overall time to result and/or introduce errors in accuracy of the overall result, such as misdetection of a positive or negative result.

A need therefore exists to continue to innovate upon fluidic devices, instruments, and overall systems for biological analysis, and more specifically for such devices, instruments and systems that rely on microscale or less volumes to perform amplification (e.g., PCR) biological on biological samples. In addition, a need exists to innovate upon the workflows associated with fluidic devices, instruments, and overall systems to provide robust, accurate, and relatively quick results, for example, that can be implemented in point-of-care diagnostics.

Additional objects, features, and/or advantages will be set forth in part in the description which follows, and in part will be obvious from the description, or may be learned by practice of the present disclosure and/or claims. At least some of these objects and advantages may be realized and attained by the elements and combinations particularly pointed out in the appended claims.

It is to be understood that both the foregoing general description and the following detailed description are for example and explanatory only and are not restrictive of the claims; rather the claims should be entitled to their full breadth of scope, including equivalents.

### BRIEF DESCRIPTION OF DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more embodiments of the present teachings and together with the description explain certain principles and operation.

FIGS. 1A and 1B are exploded views of an embodiment of a fluidic device.

FIG. 2 is a plan view of the fluidic component of the fluidic device of FIGS. 1A and 1B.

FIG. 3 is a perspective view of the fluidic component of the fluidic device of FIGS. 1A and 1B.

FIG. 4 is a partial section view taken through section 4-4 in FIGS. 2 and 3.

FIG. 5 shows comparative data of thermal cycling results for fluidic devices having a differing number of thermally insulative cutout regions adjacent a reaction chamber.

FIGS. 6A-6D shows comparative data of thermal uniformity at differing temperatures and for fluidic devices having a differing number of thermally insulative cutout regions adjacent a reaction chamber.

FIGS. 7A and 7B schematically illustrate a light manipulation surface feature that may be utilized to sense a fluid (e.g., liquid) level in a chamber.

FIG. 8 shows the detailed view of portion 8-8 labeled in FIG. 3.

FIGS. 9A and 9B are exploded views of another embodiment of a fluidic device.

FIG. 10 is a plan view of the fluidic component of the fluidic device of FIGS. 9A and 9B.

FIG. 11A is schematic perspective view a lateral flow substrate for detection of analyte.

FIG. 11B is a schematic plan view of a lateral flow substrate for detection of analyte that includes registration fiducial marks.

FIG. 12 is a front, perspective view an embodiment of an instrument for receiving a fluidic device and carrying out a biological analysis.

FIG. 13 is a back, plan view of the instrument of FIG. 12 with the instrument housing shown transparent to illustrate internal components of the instrument.

FIG. 14 is a front, plan view of the instrument of FIG. 12 with the instrument housing shown transparent and the front sensor plate removed to illustrate internal components of the instrument.

FIG. 15 is a front, perspective view of the instrument of FIG. 12 with the instrument housing shown transparent to illustrate internal components of the instrument.

FIG. 16 is a back, perspective view of the instrument of FIG. 12 with the instrument housing shown transparent to illustrate internal components of the instrument.

FIG. 17 is a front, plan view of the instrument of FIG. 12 with the instrument housing shown transparent to illustrate internal components of the instrument, including the front sensor plate.

FIG. 18 is a side view of the instrument of FIG. 12 with the instrument housing shown transparent to illustrate internal components of the instrument.

### DETAILED DESCRIPTION

### Fluidic Devices

One type of fluidic device useful for performing biological analysis assays that is relatively low cost, utilizes small sample volume, a robust fluidics and flow control mechanism, and can be disposed of utilizes a fluidics component comprising various chambers, channels, and vent pockets and a circuit component comprising addressable thermal control elements in thermal communication with one or more fluidic structures (e.g., chambers) of the fluidic component. Such a device can be configured to perform a variety of biological analysis assays, such as nucleic acid amplification, of a sample in a reaction chamber of the fluidic component and can further comprise a lateral flow device as part of the fluidics component for the detection of target analyte (e.g., nucleic acid, protein, etc.) in the biological sample. An issue that can affect the overall time from initiation of an assay to the detectable result is the overall time taken to thermally cycle or otherwise change a temperature of chambers of the device as part of the overall assay workflow. For example, by reducing the thermal cycling time, such as in chambers supporting an amplification or other temperature-dependent reaction (e.g., a polymerase chain reaction (PCR)), the overall time taken for the workflow from sample introduction to target analyte detection as a whole can be reduced. Reducing the overall time from initiation to output of a detectable result may be particularly desirable for point-of-care diagnostics. Moreover, it is desirable to reduce the time without sacrificing accuracy of the test result. In addition, the overall time and accuracy of result can further depend on the degree of thermal uniformity in a chamber supporting such a reaction. Similarly, in cases in which heating and/or cooling of a chamber or other fluidic structure is desirable in performing other processes of a workflow, even if not relating to thermal cycling, the time to bring the chamber or other fluidic structure to the desired temperature, as well as the uniformity in temperature achieved, can impact the overall time and/or accuracy of an assay using the device.

Various embodiments of the present provide for thermal rates of change occurring in fluidic structures, such as reaction chambers of a fluidic device, so as to achieve significantly reduced overall reaction times. Moreover, various embodiments of the present disclosure enhance temperature uniformity occurring within a reaction chamber that is subject to external thermal exchange to control a temperature therein. To increase thermal rates of change and/or enhance temperature uniformity, various embodiments of the present disclosure rely on one or more thermally insulative portions of the device surrounding chambers in which thermal cycling reactions and/or other change in temperature occurs. Providing fluidic devices with relatively fast thermal rates of change and thermal uniformity can be particularly advantageous for use with a variety of PCR thermal cycling applications to assist in reducing the overall time for such reactions and enhancing, for example the accuracy of the nucleic acid amplification.

Various embodiments of fluidic devices have the structure of a hermetically-sealed cassette in which the sample and other reagents to conduct reactions can be introduced and/or preloaded (e.g., in lyophilized form) can be safely introduced and contained, with the cassette being insertable into an external instrument to control various temperatures, fluidic flow, and detection aspects, among others, to carry out the biological assay. Fluidic devices may be disposable in some cases so as to avoid cross-contamination or the need to utilize other processes to address contamination, and/or to provide a relatively-low cost device, for example so as to be suitable for point-of-care applications. The cassette structure, whether disposable or not, can be relatively-low cost to make by offboarding to the external instrument the more costly control and detection components, and enabling the instrument to be used with different cassettes and programmable to achieve a variety of different biological analysis assays with such cassettes.

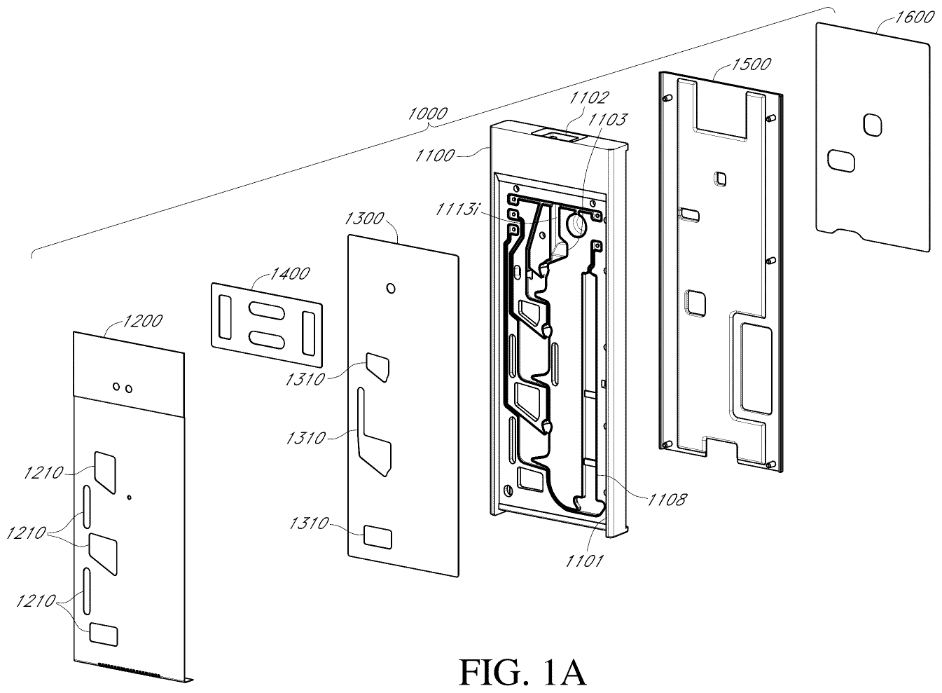

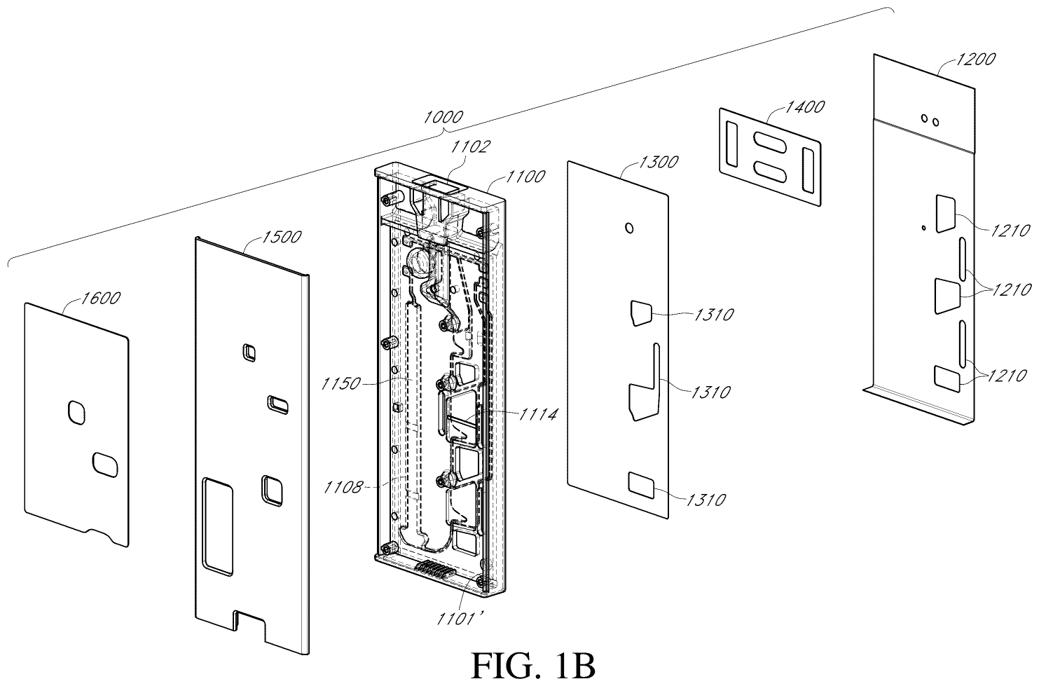

With reference to the embodiment of FIGS. 1-3, for example, a fluidic device 1000 in accordance with the present disclosure is designed for conducting a biological analysis assay that relies on a lateral flow detection and gravity with ambient pressure venting to flow a sample through a series of chambers from introduction of the sample to the device 1000 to a lateral flow substrate for detection. In one embodiment, the fluidic device 1000 is designed to conduct lysis, nucleic acid amplification, labeling, and lateral flow detection. As shown in the exploded views of FIGS. 1A and 1B (showing the exploded views from opposite faces and FIG. 1B showing the otherwise hidden portions in dashed lines), the fluidic device 1000 includes a fluidic component 1100, a circuit board component 1200, and a film (e.g., heat-labile film) component 1300. Additional components further include a shim/spacer component 1400, and cover 1500 that may be provided with a label component 1600, which may assist a user in interpreting a results provided by the lateral flow substrate. While the label component 1600 is shown as a separate label applied to the cover, such labeling could be accomplished by direct inking, etching, etc. of cover 1500.

### Fluidic Devices with Film Rupture Venting Control

In various embodiments, the fluidic component, such as fluidic component 1100, is the portion of the fluidic device which comprises various fluidic structures to receive, contain, and/or flow aqueous samples and/or reagents. The fluidic component also contains vent pockets fluidically coupled to the various chambers via capillary channels and able to be selectively vented to ambient pressure upon selective rupturing of a film component that seals the fluidic structures of the fluidic component, as described further below. The fluidic component may be made from various materials, such as a variety of plastics, and by a variety of manufacturing techniques, including ultrasonic welding, bonding, fusing or lamination, laser cutting, water-jet cutting, and/or injection molding. The various fluidic structures (e.g., chambers, vent pockets, reagent recesses, and channels) may be open at the face of the fluidic component facing the film component and circuit board component (e.g., face 1101 in FIG. 1A) and closed at the opposite face by the material of the fluidic component (e.g., face 1101′ in FIG. 1B). By utilizing an at least partially transparent material for the fluidic component, the lateral flow substrate, such as a lateral flow strip (not shown in FIGS. 1A and 1B), placed in a detection chamber 1108 can be observed from the face 1101′.

The fluidic component, such as fluidic component 1100 of the fluidic device 1000, may further comprise one or more areas within chambers or within recesses adjacent chamber that comprise lyophilized reagents that may include, for example, suitable buffers, salt, deoxyribonucleotides, ribonucleotides, oligonucleotide primers, and enzymes such as DNA polymerase and reverse transcriptase, or various other reagents that may support reactions depending on the particular application for which the fluidic device is intended. Such reagents can be spray-dried onto surfaces of the fluidic component (e.g., in chambers, recesses, etc.) or can be provided as beads or other particulate structures contained in the chambers, recesses, etc.). Such lyophilized reagents may be solubilized upon contact with the biological sample as it travels through the fluidic structures containing a reagent. In some embodiments, the first reagent recess through which a loaded biological sample travels comprises salts, chemicals, and buffers useful for the lysis of biological agents and/or the stabilization of nucleic acids present in the input sample. In some embodiments, lyophilized reagents may further include, in differing recesses and/or chambers of the fluidic component, reagents for lysing biological sample, reagents for performing nucleic amplification, such as for example PCR or RT-PCR (reverse transcriptase for the synthesis of cDNA from RNA), and/or reagents for performing exonuclease digestion.

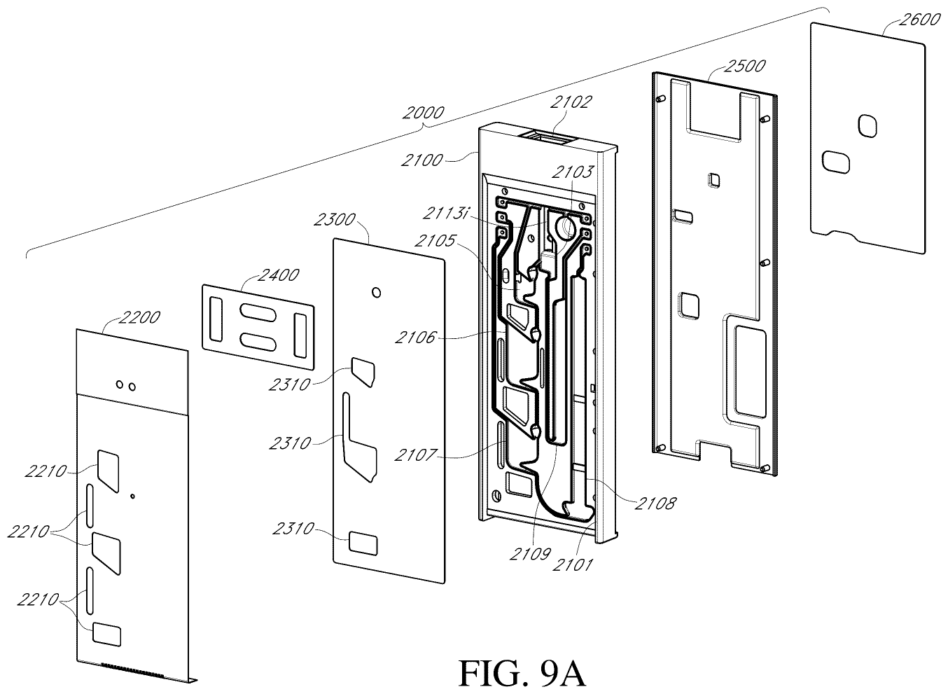

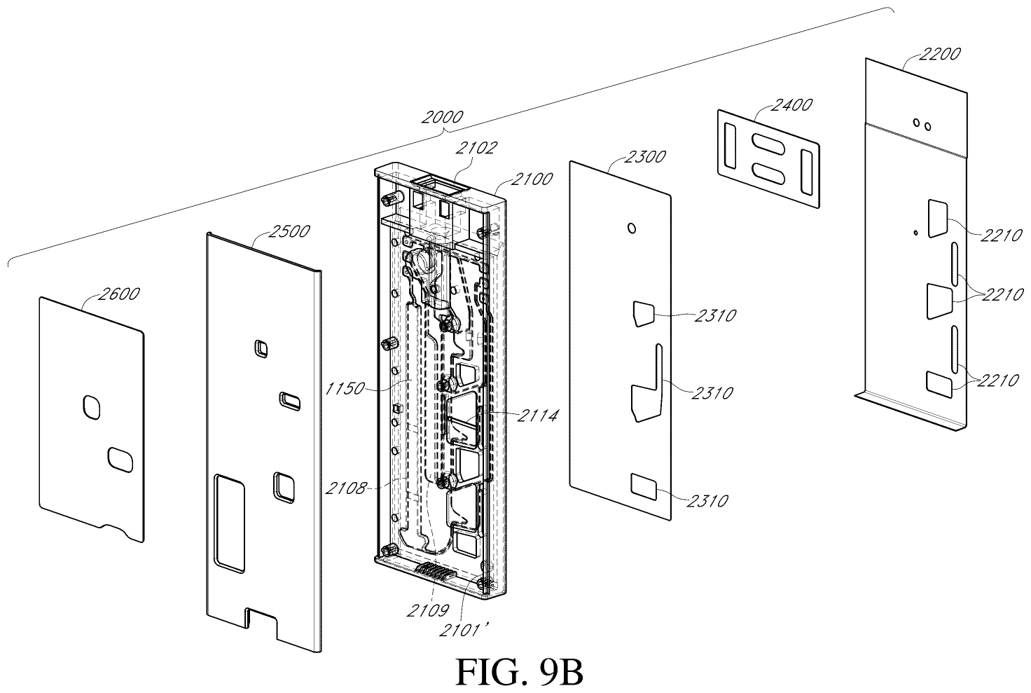

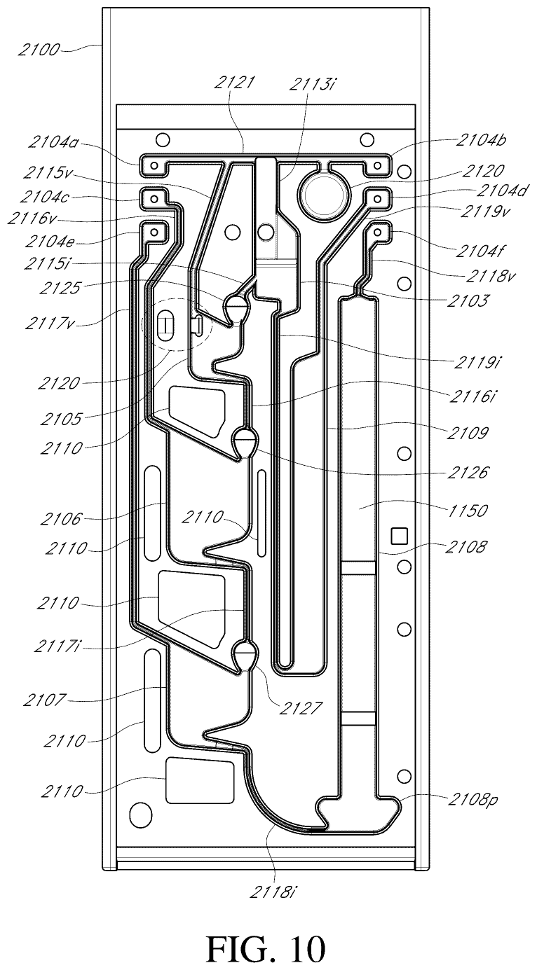

In addition, reagents contained in a fluidic device, such as fluidic device 1000 of FIG. 1A through FIG. 3 and fluidic device 2000 of FIG. 9A through FIG. 10, can include a reagent that contains detection probes. A detection probe of the present disclosure is used for labeling, for example, amplified target analyte and for labeling of amplified control. As will be described in more detail herein, a sample of detection-probe labeled amplicons, such as detection-probe labeled target analyte amplicons and detection-probe labeled control amplicons, can be detected on a lateral flow substrate that has been patterned with capture probe regions configured to capture a specific detection oligonucleotide conjugated to a detection label. Accordingly, detection-probe labeled target analyte amplicons and detection-probe labeled control amplicons can be detected at specific capture probe region locations of a lateral flow substrate by an unaided human eye or an automated detection system such as an imaging system.

Detection probe as used herein refers to a conjugate of a detectable label and detection oligonucleotide that is complementary to or otherwise able to bind specifically to the amplicon to be detected. A detection label is the portion of the detection probe that provides for a detectable emission such as fluorescence, color, etc. Accordingly, a detection probe of the present disclosure is used to label nucleic acid products (amplicons); either target analyte or control, generated during an amplification reaction for detection. For example, a detection probe can include fluorescent dyes specific for duplex nucleic acid, dye-modified oligonucleotides, such of as fluorescently-dye modified oligonucleotides, oligonucleotide-conjugated quantum dots, or oligonucleotide-conjugated solid phase elements such as a polystyrene, latex, gold, cellulose or paramagnetic particles, beads, or microspheres. As used herein, beads, particles and microspheres can be used interchangeably. As such, a detection label of the present disclose can include various beads, particles and microspheres, as well as a range of dyes including visible dyes and fluorescent dyes.

Detection of various amplicon products involves a detection oligonucleotide of the detection probe that is complementary to or otherwise able to bind specifically to the amplicon to be detected. Conjugation of a detection oligonucleotide to a microparticle can occur by use of streptavidin coated particles and biotinylated oligonucleotides, or by carbodiimide chemistry whereby carboxylated particles can be activated in the presence of carbodiimide and react specifically with primary amines present on the detection oligonucleotide. Conjugation of the detection oligonucleotide to the detectable moiety can occur internally or at the 5′ end or the 3′ end. Detection oligonucleotides can be attached directly to a detection label (e.g., the portion of the detection probe that provide for a detectable emission such as fluorescence, color, etc.), or more, for example, through a spacer moiety such as ethylene glycol or polynucleotides.

In various embodiments, the circuit board component, such as circuit board component 1200, may contain a variety of surface-mount components including but not limited to resistors, thermistors, light-emitting diodes (LEDs), photo-diodes, and microcontrollers (not shown in detail in the figures). In various embodiments, circuit board component 1200 may comprise a flexible circuit board comprising a heat-stable substrate, such as but not limited to polyimide, PTFE, glass-reinforced laminate such as FR4, PEEK, a conductive polyester film material, or other similar materials. Flexible circuits may, in some embodiments, comprise copper or other conductive coatings or layers deposited onto or bonded to the heat-stable substrate. These coatings can be etched or otherwise patterned to so as to comprise thermal control elements, such as resistive heating elements used for biochemical reaction temperature control and/or conductive traces to accommodate such heaters and/or surface mount components, such as resistors, thermistors, light-emitting diodes (LEDs), photo-diodes, and microcontrollers.

Thermal energy generation elements (not shown) (e.g., resistance heating elements, thermoelectric devices, etc.) of the circuit board component are placed in alignment and/or proximity so as to be able to transfer heat with various chambers that are to be used with controlled temperature changes during a workflow for which the fluidic device is designed to be utilized. Additionally, such thermal energy generation elements are aligned or otherwise in sufficient thermal proximity to the vent pockets in the fluidic component to enable control of flow through the fluidic component by rupturing of the film component, which may be a heat-labile material, to open the vent pockets and cause a pressure drop in a chamber fluidically coupled to the same, as is further described below. The circuit board component physical layout is further designed to provide registration with fluidic structures of the fluidic component and thermal energy generation elements of the circuit board so that various reactions that are performed under controlled temperatures can take place in those fluidic structures by thermal transfer with the respective thermal energy generation elements. Exemplary, but not limiting, reactions may include lysis, amplification, reverse transcription, hybridization, labeling. In addition, fluid flow control can be achieved by selective temperature change (e.g., heating and cooling) in some embodiments to control rupture of the film component and/or enhance pressure differentials in fluidic structures that assists in driving fluid flow through the fluidic component. The various elements on the circuit board of fluidic devices in accordance with various embodiments are put into data and electrical communication with controllers, such as provided within an external instrument with which the fluidic device can be operably coupled with, to provide the signals to control the timing of activation of the differing thermal energy generation elements, etc. of the circuit board component. Details of the various surface-mounted elements that are part of the circuit board component are not shown in the figures for purposes of simplicity.

In various embodiments, the film component, such as film component 1300, hermetically seals, along with the circuit board component, the open fluidic structures of the fluidic component. The film component may be selectively heat resistant and may be a thin film or sheet of material, such as, for example, polyolefin or polystyrene. The film component permits vent pockets to be selectively vented to a reduced pressure so as to combine pressure differentials with gravitational forces to cause fluid flow through the device. Through localized rupturing of the film component, such as via heating of a heat-labile material film component by thermal energy generation elements of the circuit board aligned with the various vent pockets, the film component may be locally ruptured at the vent pockets in a controlled and systematic fashion. This rupturing and subsequent opening of a vent pocket to a lower pressure results in the lowering of pressure in a chamber fluidically coupled to the vent pocket, thereby allowing fluid from an upstream chamber or channel to flow into the downstream fluidically coupled chamber that has been vented. In various embodiments, the vent pockets vent upon the localized rupture of the film component to an enclosed space within the fluidic component such that the gas within the fluidic device may remain sealed with respect to the environment outside of the fluidic device, which can also reduce the risk of contamination.

The various components of the fluidic device, such as fluidic device 1000, may be held together either reversibly or irreversibly, and their thermal communication may be enhanced by heat conducting materials not specifically shown. Cover 1500 serves in part as a protective sheath for the delicate components of the fluidic and circuit board components, and may also serve to facilitate sample input, buffer release, nucleic acid elution, seal formation and/or the initiation of processes required for device functionality (such as via interaction with components of an instrument providing control over the circuit board component). For example, the cover may incorporate a sample input port, a mechanical system for the formation or engagement of a seal, a button or similar mechanical feature to allow user activation, buffer release, sample flow initiation, nucleic acid elution, and thermal or other physical interface formation between electronic components and fluidic components.

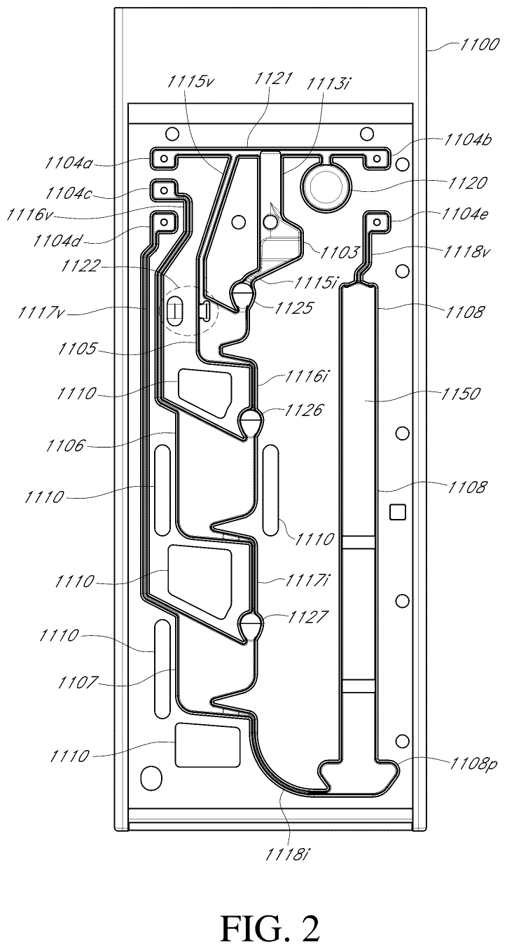

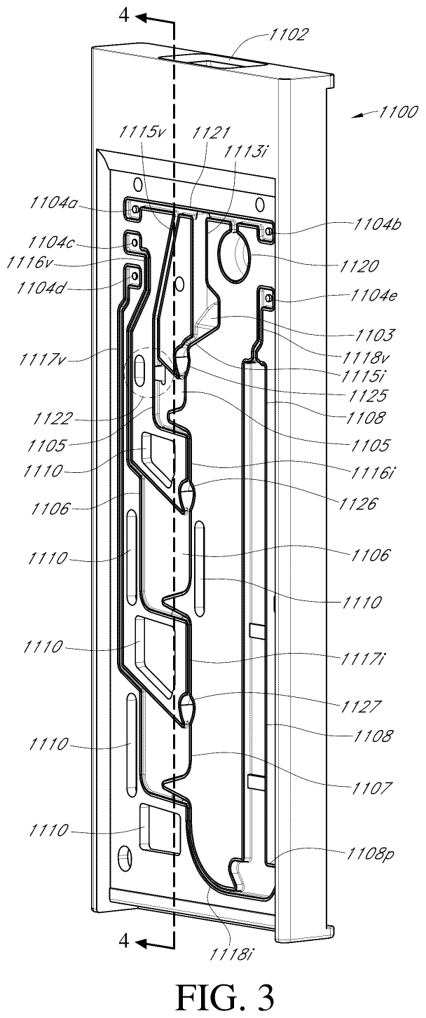

Thus, when using the fluidic device 1000 to test for an analyte (e.g., nucleic acid) of interest in a sample, with reference to FIGS. 2 and 3 showing fluidic component 1100 in isolation in the plan view of FIG. 2 and the perspective view of FIG. 3, sample can be introduced to the device through a sample inlet port 1102 of the fluidic component 1100, flow through an inlet channel 1113i and flow to a sample loading chamber 1103 and thereafter travel via the gravity and controlled, localized rupturing of the film component 1300 at locations associated with vent pockets 1104a-1104e, sequentially through the series of reaction chambers 1105, 1106, 1107 and finally to a detection chamber 1108 which contains lateral flow substrate 1150, as depicted in FIG. 1B and FIG. 2, as well as in FIG. 9B and FIG. 10.

As will be described in more detail herein, lateral flow substrate 1150 can be fabricated from an absorbent porous matrix material. The surface of a lateral flow substrate can be pattered with a capture probe in discernable patterns and shapes to create capture probe regions on the lateral flow substrate. For example, a capture probes can be patterned to create capture probe regions appearing as lines, dots, a plus sign, or a minus sign, etc. After development of a lateral flow substrate with a solution containing a sample of detection-probe labeled amplicons, for example, detection-probe labeled target analyte amplicons, detection-probe labeled control amplicons, or both, the patterned shapes of capture probes regions can provide detectable discernable patterns.

Capture probes are concentrated at a location defining a test line extending transverse to the capillary flow direction through a lateral flow substrate to form capture probe regions. Capture probe regions can patterned on a lateral flow substrate in other shape besides lines, for example dots, a plus sign, a minus sign, etc. Capture probes are configured to capture a detection oligonucleotide conjugated to a detection label. When a sufficient level of detection-probe labeled amplicons; either detection-probe labeled target analyte amplicons or detection-probe labeled control amplicons, are captured, the concentration of detection probes along a test line or other pattern of a capture probe region becomes visually and optically detectable. As such, sufficient concentration of detection probe immobilized on a patterned capture probe region of a lateral flow substrate provides an indication of presence of a detectable concentration of a target-linked template nucleic acid or control.

An exemplary use of fluidic devices in accordance with the present disclosure is described further below for an application to perform nucleic acid amplification (e.g., PCR) and lateral flow detection.

### Fluidic Devices with Thermal Enhancement Structures

To enhance the thermal rates of change occurring in a chamber in which a temperature change is desired to support a reaction or other process of a workflow, various embodiments in accordance with the present disclosure include one or more thermally insulative portions around one or more reaction chambers so as to reduce the heat sink effects that those portions of the device would otherwise produce. For example, with reference to FIGS. 1-3, the fluidic device 1000 comprises chambers 1106, 1107 and thermally insulative portions 1110 placed around the perimeters of each of the chambers 1106, 1107. In the arrangement in FIGS. 1-3, thermally insulative portions 1110 are provided at four sides of the perimeter of chamber 1106 and at three sides of the perimeter of the chamber 1107. Depending on the layout of other features of the fluidics of a microfluidic device, a greater or fewer number of thermally insulative portions may be included relative to any respective chamber. Further, a thermally insulative portion can surround more than one side of the chamber so as to surround an angular sweep radially outward of the perimeter of the chamber. In various embodiments, the insulative portion may sweep around a perimeter of a chamber from 10 degrees or more. Moreover, while two chambers 1106, 1107 in the embodiment of FIGS. 1-3 are shown as having thermally insulative portions 1110 around their respective perimeters, any number of chambers, including a single chamber, could be provided with one or more thermally insulative portions about the perimeter. Factors influencing the number, extent, and arrangement of the one or more thermally insulative portions and the number of chambers that have such thermally insulative portions around the perimeters thereof include, but are not limited to, the shape of the chamber, other fluidic structures connecting and around the chamber, the overall footprint of the device and area around the chambers, the technique and materials used to form the fluidic device, and/or the type of process or reaction occurring in a chamber (such as whether a thermal change of the chamber is occurring).

In the embodiments of FIGS. 1-3, the thermally insulative portions 1110 are in the form of cut outs (air gaps) that extend entirely through the thickness of the fluidic component 1100. However, it is envisioned that thermally insulative portions can be achieved by other mechanisms, such as by thinning out the thickness (measured in the thickness dimension (z-dimension labeled in FIGS. 2) of the device in those portions, by including relatively thermally insulative materials in those portions, or a combination of the same. By way of non-limiting example, thermally insulative materials that may be used with the various embodiments described herein include ceramics, aerogels, such as silica ceramics and aerogels, or overmolding the regions of the fluidic component at the thermally insulative portions with styrofoam or other similar material.

By utilizing one or more such thermally insulative portions surrounding some or all of the perimeter of a reaction chamber, such as reaction chambers 1106, 1107, the thermal rate of change achieved, whether for heating or cooling of the chamber, can be increased. In applications in which cooling is achieved by air flow and conduction, utilizing cut outs (air gaps) and or thinned out portions enhances the rate of cooling by creating additional air circulation around perimeter portions and/or through a thickness dimension of the device surrounding the chambers. Moreover, using one or more thermally insulative portions surrounding some or all of a perimeter of a process chamber can assist with thermal uniformity across the chamber. Enhancing thermal uniformity in turn can enhance the accuracy of the reaction, such as, for example a nucleic acid amplification (e.g., PCR), by providing temperature uniformity and hence reaction rate uniformity across the chamber.

In some embodiments, one or both of the film component and the circuit board component optionally can also include one or more thermally insulative portions arranged to be aligned with the one or more thermally insulative portions of the fluidic component. With reference again to the exploded views of FIGS. 1A and 1B, in the embodiment illustrated the circuit board component 1200 includes thermally insulative portions 1210 arranged to be in general alignment with various ones of the thermally insulative portions 1110 of the fluidic component 1110, with the exception of not including a thermally insulative portion that aligns with the thermally insulative portion 1110 to the right of chamber 1106 of the fluidic component 1100 as illustrated in FIGS. 2 and 3. The film component 1300 also includes thermally insulative portions 1310 that align with various ones of the thermally insulative portions 1110, again not including thermally insulative portions that align with thermally insulative portions 1110 that are respectively to the right of chamber 1106 and the left of chamber 1107 of the fluidic component 1100 as illustrated in FIGS. 2 and 3. As discussed above with regard to the thermally insulative portions 1110, the thermally insulative portions 1210 and 1310 can be achieved via cut-outs extending through a thickness of the circuit board component 1200 and the film component 1300. Alternatively, other implementations for achieving the thermally insulative portions 1110 and 1210 may also be feasible, such as by utilizing relatively more thermally insulative material in those regions or thinning a thickness dimension of the material in those regions. However, the formation of such thermally insulative portions in any of the layers of the fluidic device 1000 may be limited in practice depending on an overall thickness dimension and nature of the material of the particular component in which the thermally insulative portions are provided. In some embodiments, it is envisioned that while a thermally insulative portion may be achieved in the fluidic component 1100 via use of thinner walls and/or a relatively thermally insulative material, the circuit board component 1200 and/or the film component 1300 may nonetheless have thermally insulating portions that are achieved via air gaps (i.e., removal of material through a thickness of the component). In yet further embodiments, the circuit board component 1200 and/or the film component 1300 may not have thermally insulative portions and instead only the fluidic component may be provided with the same. The number and arrangement of the thermally insulative portions in each of the circuit board component 1200 and the film component 1300 may differ from each other and not necessarily match (align with and/or have same shape/size of) with the thermally insulative portions of the fluidic component. As described above with respect to the fluidic component, the number, configuration, and arrangement of thermally insulative portions of either circuit board component 1200 or the film component 1300 may vary based on a variety of factors, including, but not limited the shape of a chamber to be thermally insulated, other structures that may be a part of the circuit board or film component, the overall footprint of the circuit board or film component, the technique and materials used to form the circuit board component and/or film component.

Various embodiments of the present disclosure further contemplate a reaction chamber, such as a PCR reaction chamber, having an increased surface area to volume ratio to increase thermal rates of change and/or enhance thermal uniformity in the chamber. Further, various embodiments of the present disclosure contemplate utilizing one or more relatively thin wall portions in the thickness dimension of the device (measured in z-direction as identified in FIG. 2) surrounding a reaction chamber, such as a reaction chamber in which a thermal cycling (e.g., PCR) reaction is to occur, to increase thermal rates of change and/or enhance thermal uniformity.

With reference again to the embodiments of FIGS. 1-3, the reaction chamber 1106 has a relatively larger cross-section and overall area footprint, for example in comparison to reaction chamber 1107 that is not used for thermal cycling and/or nucleic acid amplification. For example the reaction chamber in which a thermal cycling and/or amplification reaction is to occur may have a larger surface area-to-volume ratio than other types of reaction chambers. The surface area considered when determining the surface area to volume ratio is the surface area of the cross-section of the chamber taken in a longitudinal plane of the fluidic component, such as the longitudinal plane along 4-4 denoted in FIGS. 2 and 3. Differing surface area-to-volume ratios of various chambers of the device can be applied to differing chambers than those of the embodiments illustrated herein and may depend on the intended use of the fluidic device and thus structural arrangement, number, and configurations of the chambers so as to achieve an intended workflow. When considering surface area-to-volume ratios for a reaction chamber in which thermal cycling is to occur, design considerations include to maximize the surface area-to-volume ratio to achieve

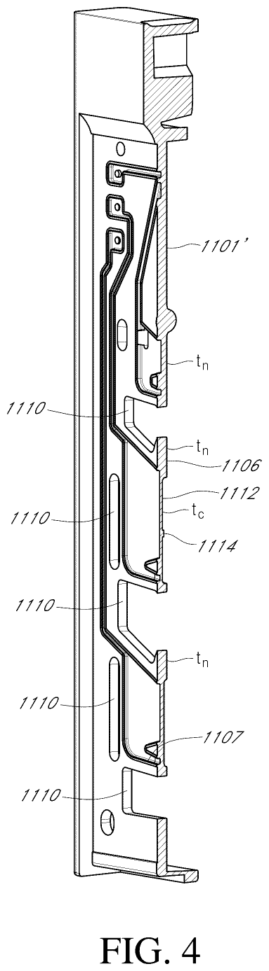

In various embodiments, the wall, or portion thereof, of a reaction chamber at the face of the chamber facing the cover may be relatively thin. For example, the wall, or portion thereof, may be thinner than a nominal wall thickness of portions of the fluidic component surrounding the periphery of the chamber. With reference to FIG. 4, for example, which shows a detailed partial sectional view taken through the section 4-4 in FIGS. 2 and 3, the thickness t_{c} of the end wall of chamber 1106 that faces the face 1101′ is thinner than the nominal wall thickness tₙ of the fluidic component 1100. In various other embodiments, it is contemplated that the entire nominal thickness of the device could be substantially uniform and relatively thin to achieve desired thermal enhancement, however, in some case manufacturing tolerances may not permit such thinning of the fluidic component thickness throughout and in such cases at least the chambers, such as a reaction chamber 1106 that may be subject to thermal cycling or other temperature-dependent reactions, may be made with a wall thickness that is relatively thin and less than that of the nominal thickness of the fluidic component. In embodiments in which the fluidic component 1100 is injection-molded, the thickness to of the end wall may range from about 0.51 mm (0.020 in.) to about 1.02 mm (0.040 in.), for example about 0.76 mm (0.030 in.) to about1.02 mm (0.040 in.) and the nominal wall thickness may be about 1.27 mm (0.050 in.) to about 2.89 mm (0.090 in.), for example about 1.27 mm (0.070 in.). Other manufacturing processes are envisioned, however, that could achieve reduced thickness dimensions, such as, laminating and/or welding a thin film to produce the end wall of the chamber. The wall thicknesses of other chambers, such as chamber 1105, 1107 may also be smaller than the nominal thickness, however, in chambers in which thermal cycling or rapid temperature changes and/or temperature uniformity do not have as great an impact on performance of an intended reaction and/or overall workflow, the thickness may be thicker than in other reaction chambers such as chamber 1106 intended to be used for thermal cycling and amplification for example.

To promote structural integrity in chambers that may have relatively thin end wall portions, some embodiments may use a reinforcement structure. For example, with reference to FIGS. 1B and 4, chamber 1106 is provided with a small region of thicker material along a part of the end wall 1112. In the embodiment depicted, the small region is a rib 1114 that extends across the chamber 1106, but other shapes, sizes, and arrangements of reinforcement members are contemplated. Such reinforcement structures can also assist with manufacturing, such as molding and ultrasonic welding of the fluidic component.

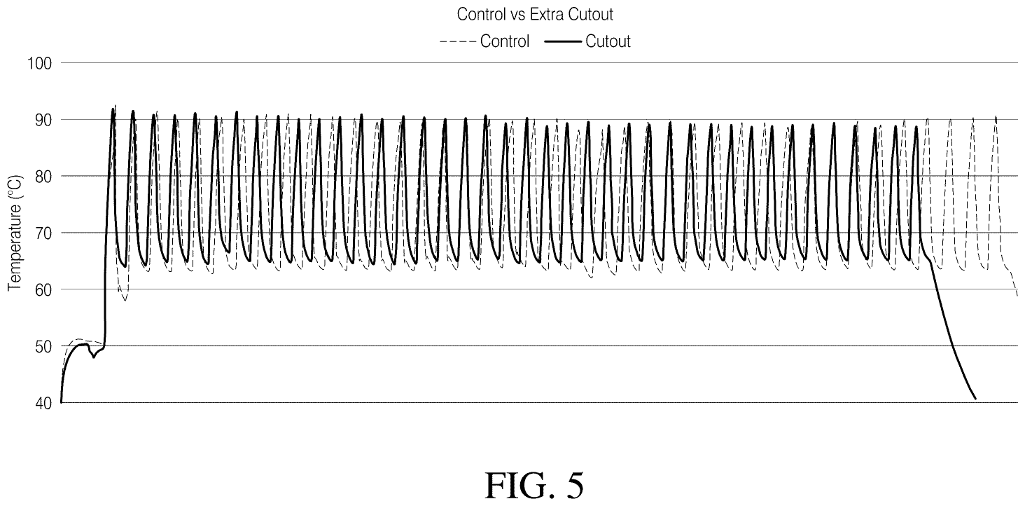

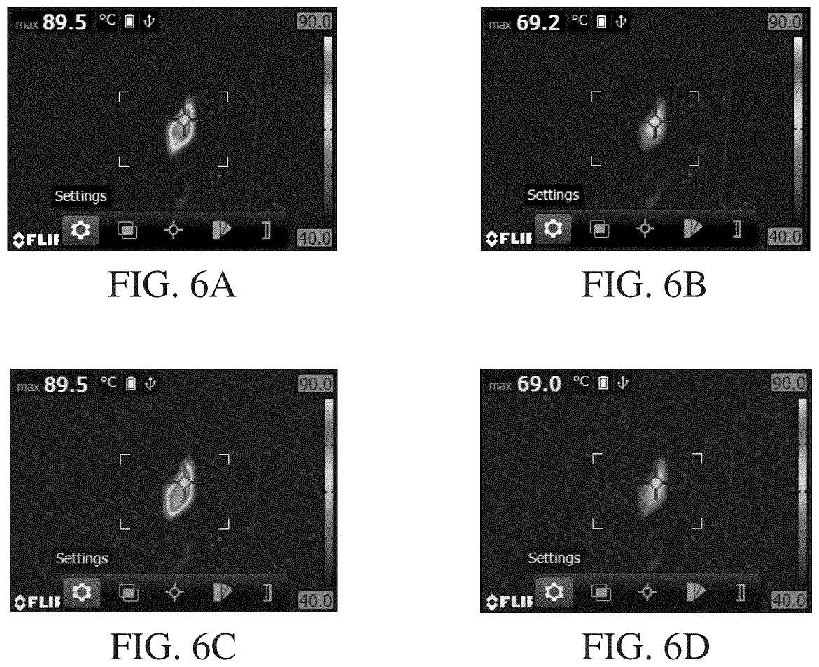

FIGS. 5 and 6A-6D depict comparative results of thermal cycling of a fluidic component comprising a reaction chamber with four cutout thermally insulative portions around the perimeter, as shown in the embodiments of FIG. 1-3, and a reaction chamber with only 3 such cutouts around the top, bottom, and left sides from the view in FIG. 1A. As can be seen in FIG. 5, showing temperature in the chamber versus time, the shorter trace (40 cycles in 7.5 minutes) corresponds to the chamber surrounded by the four cutouts (cutout in the figure) and the longer trace (40 cycles in 9 min.) corresponds to the chamber with three cutouts (considered the control in the figure). It can be seen by the relative peaks and timing of those peaks that the chamber with the four cutouts around the perimeter is able to thermally cycle faster than that with three cutouts. More specifically, the chamber with the four cutouts FIGS. 6A-6D illustrate the comparison of thermal uniformity at relatively high temperature (˜89.5° C. in FIGS. 6A and 6C) and low temperature (˜69° C. in FIGS. 6B and 6D) for the chamber with the four cutouts (FIGS. 6C and 6D) and the chamber with the three cutouts (FIGS. 6A and 6B). As can be seen, while the chamber with three cutouts shows good thermal uniformity across the chamber, the chamber with four cutouts exhibits more thermal uniformity across the chamber in comparison. Overall, the results of FIGS. 5 and 6 demonstrate the thermal enhancement and uniformity effects that providing a single thermally insulative portion at a perimeter of a reaction chamber can have. With a more even temperature distribution, a greater volume of the reaction solution can achieve the target temperature.

Various embodiments described herein may achieve a significant reduction in the overall PCR thermal cycling by employing the thermally insulative portions and chamber configurations as described above. For example, the PCR thermal cycling time may be reduced by 25% or more, and up to 50%. In various embodiments, for a volume of sample on the order of 60 microliters being subjected to PCR, the change in including an additional cutout around the PCR chamber can be seen from FIG. 5 to result in a thermal cycle time of about 100 seconds for 40 cycles. It is expected further that faster overall thermal cycling times can be achieved by narrowing the range between the temperatures at which annealing and denaturation occur.

### Fluidic Devices with Fluid Flow Control Structures

The present disclosure further contemplates embodiments of fluidic devices that utilize one or more fluid flow control structures. Such fluid flow control structures can include mechanisms to ensure a sufficient volume of sample fills the device upon loading and/or for further flow throughout the various chambers and channels of the device.

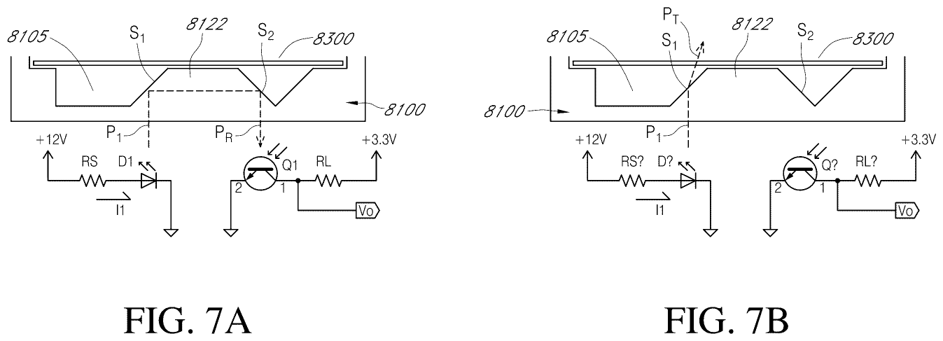

For example, various embodiments of fluidic devices may use optical manipulation features for fluid sensing. Such optical manipulation features can be a surface feature arranged with respect to a chamber (or other fluidic containment structure) in which fluid sensing is desired and that permit light to be manipulated in differing patterns depending on whether the chamber contains a desired volume of a fluid. FIGS. 7A and 7B conceptually illustrate a light manipulation surface feature that may be utilized to sense a fluid (e.g., liquid) level in a chamber. With reference to FIGS. 7A and 7B, a cross-sectional view of a fluidic component 8100 of a fluidic device (such as similar to fluidic component 1100, 2100 (described further below)) taken transverse to the longitudinal axis and across a chamber 8105 covered on its open side with the film component 8300 is illustrated schematically. As illustrated, an optical manipulation surface feature comprises a prismatic surface feature 8122 formed in a wall of the chamber within the chamber volume (e.g. interior of the facing the film component). Utilizing such a surface feature and appropriate materials for the surface features as well as known light transmission and reflectance properties of air and fluid that will be filling the chamber for a given workflow allows predictable light manipulation changes that can be detected to provide confirmation that a chamber has been filled to a desired level with a fluid of interest. Turning again to FIG. 7A, for example, when the chamber 8105 at the height of the optical manipulation surface feature 8122 is not filled with the working fluid, the surface feature 8122 is configured to achieve a first light manipulation pattern. For example, light directed along path P1 toward a first surface portion S1 of the prismatic surface feature 8122 is not transmitted into the chamber 8105 and is instead reflected back toward the source from the other angled surface portion P2. A sensor (illustrated by the circuit diagram in FIG. 7A) can thus be triggered to detect the light reflected back along path PR to determine the chamber 8105 has not been filled to the desired level.

In a state of the chamber 8105 being filled to the desired level, as depicted in FIG. 7B, such as with a liquid sample, the optical manipulation surface feature 8122 can be such that the light directed along path P1 toward the first angled surface portion S1 is at least partially transmitted and refracted through the first angled surface S1 (as a result of the liquid overlying the surface S1) and does not get reflected back (or is reflected back in a lesser amount) toward the sensor (again illustrated by the circuit diagram in FIG. 7B). The sensor can thus detect by sensing of the amount of light reflected back (including no light reflected back) to the sensor if the chamber has been sufficiently filled. The optical manipulation feature and corresponding sensor can be modified such that relative amounts of light sensed trigger the sensor to know if a sufficient level of fluid has filled the chamber, or such that no light sensed could be associated with a sufficiently filled chamber and light sensed could be associated with a chamber not sufficiently filled.

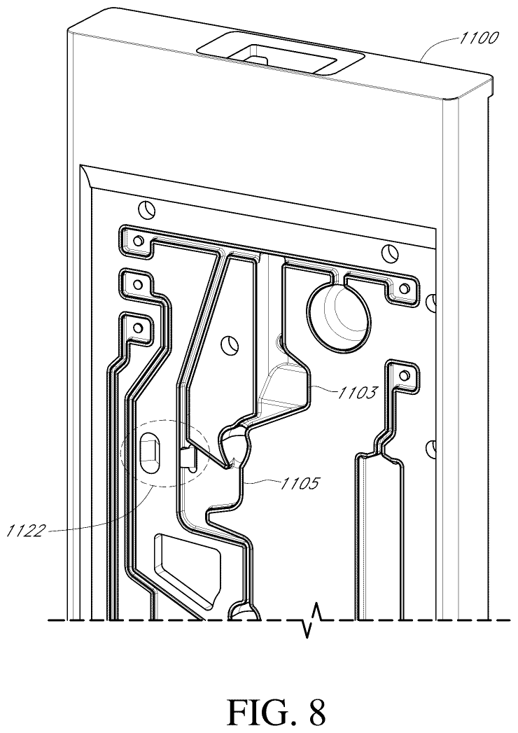

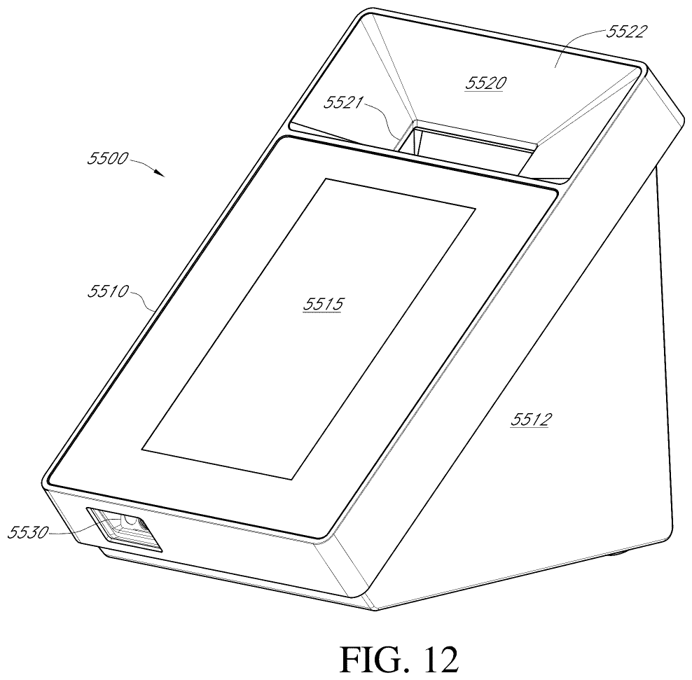

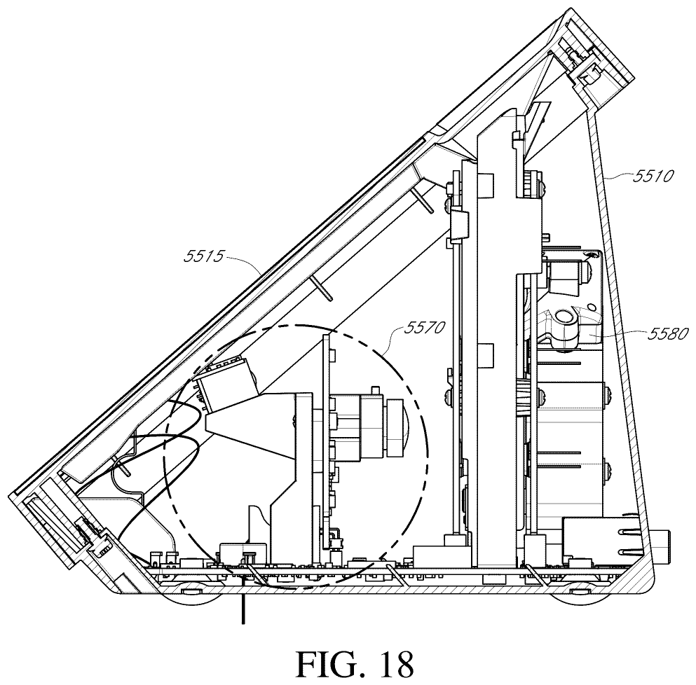

With reference to FIGS. 2, 3, and 8, the latter of which shows the detailed view of portion 8-8 labeled in FIG. 3, the fluidic component 1100 comprises an optical manipulation surface feature 1122 comprising a prismatic surface feature just outside the chamber 1105 and the reflective angle formed proximate the upper (inlet side) of the chamber 1105 and at a level at which it is desired for the fluid to fill the chamber 1105. FIGS. 7A and 7B represent the cross-section of the area 1122 of FIG. 8. The light source and sensor components may be provided as external components, such as, for example, stand-alone components or as part of an instrument in which the fluidic device 1100 is configured to be operably coupled (e.g., inserted) to provide the controls and various functionality to the circuit board component 1200. One embodiment of such an instrument implementing the light source and sensor component configured to cooperate with the optical manipulation surface feature of embodiments of a fluidic device as described herein is described further below with reference to FIGS. 12-18.

An optical manipulation feature such as those described herein may be associated with any number of chambers of a fluidic device for which it is desired to sense the level of sample. Moreover, such optical based sensing for detecting liquid level can be used in conjunction with other techniques for detecting liquid level, such as, for example, temperature sensing, pressure sensing, or other techniques.

As mentioned above, it is desirable to ensure a sufficient amount of sample is initially loaded into various embodiments of fluidic devices in accordance with the present disclosure such that enough sample is provided to drive the gravity-based flow through all of the chambers of the device. Further, it is desirable to ensure a sufficient amount of sample is loaded to solubilize reagents in the device and/or otherwise support the desired reactions in the device, such as, for example, PCR and a detection reaction resulting from the contact with and travel through the lateral flow substrate, among others. In some embodiments herein, it is contemplated that a sufficient amount of sample is initially loaded in a predetermined amount, for example, via a pipette or other loading mechanism, with predefined volume being loaded from the pipette to ensure the remaining workflow using the device can be performed. Other embodiments contemplate a fluidic device having built-in metering (self-metering) so that a volume in excess of that needed to ensure complete and accurate flow of the sample through the various chambers of the device for a complete workflow can be initially loaded into the device. From the initially loaded larger volume, the amount of sample that is sufficient to ensure the flow through the device for completion of the workflow can be used.

FIGS. 9A and 9B illustrate exploded views of a fluidic device having built-in metering (similar to the views of fluidic device 1000 in FIGS. 1A and 1B) and FIG. 10 illustrates a plan view of the fluidic component of the fluidic device. The fluidic device 2000 shown in the embodiment of FIGS. 9A and 9B may have generally the same components (layers) as fluidic device 1000 of FIGS. 1A and 1B, and the fluidic component 2100 also may have similar paths as fluidic component 1100, and thus will not be described here in detail again. Additionally, as depicted in FIG. 9B and FIG. 10, detection chamber 2108 contains lateral flow substrate 1150, as depicted and previously described herein.

To the extent various parts are discussed for the purposes of describing the metering functionality, parts of fluidic device 2000 that are similar in structure and function to the parts of fluidic device 1000 in the embodiment of FIGS. 1-3, the parts are labeled with reference numbers that begin with 2000 series and end with the three digits that are the same as the 1000 series used in FIGS. 1-3.

Accordingly, the following description will focus on portions of the fluidic device 2000 that differ from fluidic device 1000 described above. In the embodiment of FIGS. 9 and 10, the fluidic component 2100 of fluidic device 2000 comprises a waste chamber 2109 fluidically coupled to the sample loading chamber 2103 via a capillary channel 2119i, which serves as the inlet path for sample to flow from the chamber 2103 into the waste chamber 2109. The capillary channel 2119i fluidically couples to the sample loading chamber 2103 at a location lower than (in the orientation of the fluidic device in FIGS. 9 and 10 and in an operational state to achieve gravity-driven flow through the fluidic component) the capillary channel 2115i which fluidically couples the sample loading chamber 2103 to the first reaction chamber 2105 in the series of reaction chambers 2105, 2106, 2107. In other words, in a state of the sample loading chamber 2103 containing liquid (e.g., sample), the pressure head acting on the capillary channel 2119i is larger than that acting on the capillary channel 2115i. The waste chamber 2109 further is fluidically coupled to a vent pocket 2104d via capillary channel 2119v, in a manner similar to how the reaction chambers 2105, 2106, and 2107 are coupled to respective vent pockets 2104a, 2104c, 2104e.

The configuration of the sample loading chamber 2103, initial reaction chamber 2105, and waste chamber 2109, with the respective fluidic couplings of the capillary channels 2115i, 2115v, 2119i, and 2119v, and vent pockets 2104a, 2104d, with controlled venting of the vent pocket 2104d by localized rupture of the film component 2300 at a location aligned with the vent pocket 2104d enables sample from the sample loading chamber 2103 to first flow into the reaction chamber 2105, flowing first through the capillary channel 2115i and any reagent that is in reagent recess 2125. Due to the relative arrangements and sizes of the capillary channels 2115i, 2115v, 2119i and chambers 2103 and 2105, the sample from sample loading chamber 2103 will drain into chamber 2105 without being pulled into capillary channel 2119i until an equilibrium between the chamber 2105 and chamber 2103 is reached. The volumes of the chambers 2103 and 2105 and the volume of sample initially loaded into chamber 2105 may be such that the sample will fill the chamber 2105 in a desired amount (level) that is predetermined to be sufficient to carry out the rest of the fluidic component 2100 so as to carry out the desired workflow. In an embodiment comprising an optical manipulation feature for fluid level sensing, the volume desired to fill the chamber 2105 is at least to the level of the optical manipulation feature 2122. In some cases, the volume drained into chamber 2105 from chamber 2103 may be such that it rises to some extent into capillary channel 2115v before reaching equilibrium. Once the equilibrium has been reached and no further sample is draining from chamber 2103 into chamber 2105, which can be sensed for example via utilization of the optical manipulation feature 2122 operating in a manner similar to that explained above with regard to the embodiment of FIG. 8 or by another sensing mechanism, including for example, a known time period expected to have passed, the film component 2300 may be ruptured proximate the vent pocket 2104d, causing any sample remaining in chamber 2103 to flow through the capillary channel 2119i and into the waste chamber 2109. The configuration of the narrowed and angled chamber leg portion of chamber 2103 that connects to the capillary channel 2119i assists in creating forces on the sample in the chamber 2103 that promote flow of the sample into the capillary channel 2119i and waste chamber 2109, as opposed to flowing back and into the channel 2115i, chamber 2105 and channel 2115v.

In yet other embodiments, due to the pressure venting and gravity-assisted techniques to cause fluid flow through the various chambers and channels of a fluidic device, venting and circulation of air (or other gasses) that may otherwise become trapped in undesirable locations of the fluidic device (e.g., channels and/or chambers) is desirable. Various embodiments thus contemplate the use of a common expansion structure that allows for sufficient venting, collection, and recirculation of gasses as vent pockets dedicated to the various chambers of the device are opened and cause the pressure differentials that drive fluid flow sequentially through the fluidic device. With reference again to the embodiments of FIGS. 1-3 and FIGS. 9 and 10, the fluidic component 1100, 2100 comprises toward an inlet end of the fluidic component 1100, 2100 a common expansion structure comprising a channel 1121, 2121 (also referred to herein as common or expansion channel) fluidically coupled at each end to vent pockets 1104a, 1104b, 2104a, 2104b (also referred to as common vent pockets), and at respective branched junctions (e.g., T-junction) to the channel 1115v, 2115v and inlet channel 1113i, 2113i which fluidically couples to the inlet port 1102 to introduce the sample loaded into the fluidic component 1100, 2100 to the sample loading chamber 1103, 2103. The common expansion structure further comprises an expansion chamber 1120, 2120 fluidically coupled to the expansion channel 1121, 2121 via a branched junction (e.g., T-junction). The expansion chamber 1120, 2120 also may contain a desiccant to assist with collection of excess moisture within the device that may be carried by the vented gasses. By providing the vent pockets 1104a, 1104b, 2104a, 2104b on the opposite sides of the fluidic component and connected to the common channel 1121, 2121m and opening those vent pockets 1104a, 1104b, 2104a, 2104b before or with the initial flowing of the loaded sample from the sample loading chamber 1103, 2103, gas that moves through the fluidic component 1100, 2100 as fluid flows through the chambers in response to the other vent pockets 1104c-1104e, 2104c-2104f being opened can be collected by the common expansion structure, including by providing a sufficient volume of the expansion chamber 1120, 2120. The common expansion structure further serves to allow for a recirculation pattern of gas through the fluidic component 1100, 2100 as fluid is moved through the various channels and chambers, and accordingly gas is displaced and flows to different portions of the fluidic component 1100, 2100 as well.

### Fluidic Devices with Optical Registration

In using fluidic devices in conjunction with various instruments, for example to provide control over the circuit board component, sensing, and/or other functionality, as described above, it may be further desirable to provide registration of the fluidic device when inserted into an instrument to ensure proper insertion and positioning of the fluidic device in the instrument, to trigger timing to accomplish automated control over the workflow, and/or to permit accurate optical detection of subsequently developed test results (such as, e.g., a test result relating to an assay returning a positive, negative, and/or control result).

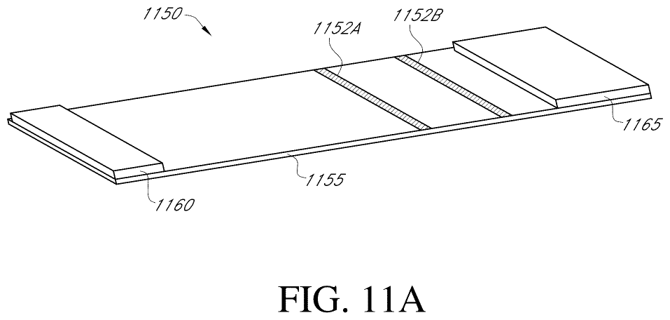

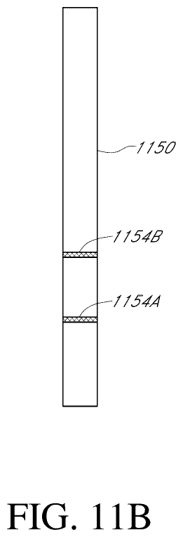

Various embodiments in accordance with the present disclosure contemplate using a fiducial mark on a lateral flow substrate of a fluidic device as a mechanism to verify registration of the fluidic device inserted within an instrument. As used herein, fiducial mark and registration fiducial mark can be used interchangeably. With reference to FIG. 11A, lateral flow substrate 1150 is depicted. Lateral flow substrate 1150 can be configured for use in a lateral flow assay and contained in a detection chamber of a fluidic device, such as the detection chambers 1108 or 2108 of the fluidic devices 1000 or 2000 previously described herein (see FIGS. 1B/2 and FIGS. 9B/10, respectively).

Lateral flow substrate 1150 of FIG. 11A can be incorporated into fluidic device 1000 of FIG. 1A-FIG. 3 or with fluidic device 2000 of FIG. 9A-10. Lateral flow substrate 1150 include be an assembly of layers of materials. For example, lateral flow substrate 1150 can detection substrate 1155 of a porous material and additionally may include surfactant pad 1160 and absorbent pad 1165. Alternatively, when surfactant pad 1160 and absorbent pad 1165 are not fabricated with lateral flow substrate 1150, then lateral flow substrate and detection substrate can be used interchangeably. Detection substrate 1155 can be fabricated from a porous matrix, for example, nitrocellulose, cellulose, polyethersulfone, polyvinylidine fluoride, nylon, charge-modified nylon, or polytetrafluoroethylene and may be backed with a plastic film (not shown). As previously described herein, a capture probe can be deposited and irreversibly immobilized on detection substrate in various discernable patterns and shapes to create capture probe regions, such as capture probe region 1152A and 1152B of FIG. 11A. Capture probe region 1152A and 1152B can be uniquely located on lateral flow substrate 1150 to correspond to where capture probes are deposited for a target analyte versus where capture probes are deposited for a control. As such, and as will be described in more detail herein, a location on lateral flow substrate 1150 corresponds to a capture probe region correlated to a specific response, i.e. test or control. Accordingly, when a lateral flow substrate is developed with a solution containing a sample of detection-probe labeled amplicons, for example, detection-probe labeled target analyte amplicons, detection-probe labeled control amplicons, or both, a discernable pattern corresponding to a location of target analyte versus a discernable pattern corresponding to a location of a control can be visualized by the unaided human eye or an automated detection system such as an imaging system.

It should be noted that multiplexing can be conducted in an amplification chamber in which multiple primer pairs simultaneously generate and amplify multiple different target template nucleic acids, as well as multiple assay controls. Accordingly, a single lateral flow substrate, such as lateral flow substrate 1150 of FIGS. 1B/2, FIGS. 9B/10, and FIGS. 11A/11B, can be patterned with multiple capture probes specific to each target amplicon and each control. As such, multiplexed detection that includes a plurality of capture probe regions can be performed for detection of multiple target amplicons and well as multiple assay control, for example, positive and negative controls.

When lateral flow substrate 1150 is assembled to include surfactant pad 1160 attached at the upstream end of detection substrate 1155, surfactant pad 1160 can be fabricated using a porous substrate, preferably with minimal nucleic acid binding and fluid retention properties, that permits unobstructed migration of the nucleic acid product and detection microparticles. Surfactant pad 1160 can be fabricated from materials such as glass fiber, cellulose, or polyester, which can be coated with a amphipathic surfactant to allow uniform migration of fluid through detection substrate 1155, and therefore uniform migration of sample through the detection substrate 1155. For variations of lateral flow substrate 1150 including an absorbent pad attached at the downstream end of detection substrate 1155, absorbent pad 1165 can be fabricated from any absorbent material that promotes sample wicking through lateral flow substrate 1150.

As depicted in FIG. 11B, lateral flow substrate 1150 can include one or more registration fiducial marks, such as fiducial marks 1154A and 1154B of FIG. 11B, which are present at an initial use. The one or more registration fiducial marks can be detected by optical detection (e.g., camera or other imaging device) and/or visible to the naked eye. Providing registration fiducial marks, such as fiducial marks 1154A and 1154B, that are present prior to the initiation of an assay can facilitate optical detection of subsequent test results by enabling an optical sensor to receive information regarding a location at which to monitor the presence or absence of detection signal for one or more of a capture probe region correlated to a target analyte or correlated to an assay control.

The one or more registration fiducial marks, such as fiducial marks 1154A and 1154B of FIG. 11B, can be configured so as to disappear upon an aqueous substance (such as a sample fluid to be assayed using the lateral flow test device) permeating through lateral flow substrate 1150 and into contact with a registration fiducial mark. In this way, potential confusion with an analyte presence indicator and/or control indicator that are included in a capture probe region of the lateral flow substrate can be avoided. The sensing device, such as a camera or other imaging device (e.g., a charged-coupled device (CCD) or complimentary metal-oxide semiconductor (CMOS) image sensor) may be provided as an external mechanism, such as part of an instrument (an embodiment of which is described further below with reference to FIGS. 12-18), into which the fluidic device is to be inserted for control over the workflow thereof. In various embodiments, as discussed above, the fluidic component and a cover that provides protection for the fluidic device, such as fluidic components 1100 or 2100 and covers 1500 or 2500 of the fluidic devices 1000 or 2000 described above, can be at least partially transparent so as to permit observation and sensing of the lateral flow substrate 1150 inserted into the detection chamber, such as in detection chambers 1108 or 2108 of FIGS. 1B/2 and FIGS. 9B/10, respectively. The location, size, and shape of registration fiducial marks 1154A and 1154B illustrated in FIG. 11B is not limited and other locations, sizes, and shapes are considered within the scope of the present disclosure and can be selected based on a variety of factors, such as, but not limited to, relative positioning of one or more capture probe regions of the lateral flow substrate in which test or control development indicators will be located, the direction in which fluid to be initially introduced to and permeate (wick) through a lateral flow substrate, the ability of a fiducial mark to be sensed and distinguished by an optical sensing device, such as a CCD, CMOS, or other imaging device, and various other similar factors.

In one embodiment, a registration fiducial mark, such as registration fiducial marks 1154A and 1154B illustrated in FIG. 11B, is formed from a dye that is added to the capture moiety (e.g., (such as to oligonucleotides) that is included in the lateral flow substrate for binding to the target analyte for which the fluidic device is designed to detect. The dye may be water-soluble and washed away upon contact with the aqueous sample being tested such that it disappears from the lateral flow substrate and does not interfere with the observation of other fluorescent or colorimetric detection of analyte. In various exemplary embodiments, the dye is selected so as to be non-reactive with the assay being conducted in the fluidic device. For example, a food-grade coloring dye may be used. However, a variety of optically-detectable dyes can be used that meet the criteria of being removed from a capture probe region with the solution front wicking through the lateral flow substrate to prevent interference with the observation of other fluorescent or colorimetric detection of analyte.

### Fluidic Device Workflow to Perform Nucleic Acid Amplification and Lateral Flow Detection

In some embodiments, fluidic devices are configured for conducting lysis, nucleic acid amplification (e.g., PCR or reverse-transcription PCR (RT-PCR)), exonuclease digestion, and lateral flow detection. When using embodiments of fluidic devices for such workflows, the various reagents used to conduct the various reactions can be provided as dried or lyophilized reagents located in recesses along the channels between, for example upstream of a chamber for which the reagent is to be used.

The following description provides an embodiment of a workflow for conducting lysis, nucleic acid amplification (e.g., RT-PCR), exonuclease digestion, and lateral flow detection, with reference to the embodiments of the fluidic devices of FIGS. 1-3 (without built-in metering) and FIGS. 9 and 10 (with built-in metering). To initiate the workflow, a sample to be analyzed for a nucleic acid analyte of interest is loaded into the fluidic device 1000, 2000 through inlet port 1102, 2102. The sample may be loaded through a variety of loading mechanisms, as described above, including but not limited to pipette, a syringe, a swab, a cuvette, or a variety of other sample loading mechanisms. The orientation of the fluidic device 1000, 2000 so as to have its longitudinal dimension generally parallel to the force of gravity permits the loaded sample to flow through the inlet channel 1113i, 2113i and into the sample loading chamber 1103, 2103. The inlet channel 1113i, 2113i, has a large enough volume such that the path of least resistance is to the sample loading chamber 1103, 2103, without venting. From the sample loading chamber 1103, 2103, and with the common vent pockets 1104a, 1104b, 2104a, 2104b opened, which can occur by timed puncture (e.g., rupture via heating from one or more thermal energy generation elements of the circuit board component 1200, 1300 aligned with the vent pockets 1104a, 1104b, 2104a, 2104b) of the film component 1300, 2300 at locations aligned with the common vent pockets, the opened the sample travels through capillary channel 1115i, 2115i through a reagent recess 1125, 2125 to chamber 1105, 2105, mixing and washing the reagent from the reagent recess 1125, 2125 into the chamber 1105, 2105. Displacement of gas can occur during the flowing of the sample from the chamber 1103, 2103 to the chamber 1105, 2105 into the common expansion structure. The chamber 1105, 2105 can be used for conducting a lysis reaction and thus may be referred to as a lysis chamber in the workflow embodiment described.

The reagent recess 1125, 2125 may thus contain lyophilized reagent for performing a lysing reaction of the sample. In various embodiments, the reagent may comprise salts, chemicals (e.g., dithiothreitol) and buffers (e.g., to stabilize, increase, or decrease pH) useful for the lysis of biological agents and/or the stabilization of nucleic acids present in the input sample. Suitable lysis reagents may include, for example, lysozyme, lysin, zymolase, glycanase, proteases, yeast lytic enzyme, or combinations thereof. In some embodiments, the sample is heated in the lysis chamber 1105, 2105, for example, by one or more thermal energy generation elements of the circuit board component 1200, 2200 aligned with the lysis chamber 1105, 2105.

Once a sufficient volume of sample has filled the lysis chamber 1105, 2105, as detected, for example, by use of the optical manipulation feature 1122, 2122 and fluid level sensing technique, described above, and/or via detection of a change of temperature of the chamber 1105, 2105 due to sample entering the chamber, the workflow can continue in somewhat different ways depending on which embodiment of fluidic device 1000, 2000 is being used. In the case of detection of a change of temperature, sensing such a change can occur directly using a temperature sensor such as an IR or other type of sensor and/or indirectly via monitoring a circuit used to maintain a temperature of the chamber (e.g., to an elevated temperature by powering a thermistor). When the circuit draws more power to achieve the desired temperature, due to sample flowing into the chamber and causing the temperature to decrease, the extra power can be the signal for determining the fluid has filled the chamber. The circuit and/or other temperature sensing device can be part of an instrument into which the fluidic device is insertable, one embodiment of which is described further below with reference to FIGS. 12-18. In fluidic device 2000, which employs built-in metering as described above with reference to FIGS. 9 and 10, the sample introduced through inlet port 2102 flows through inlet channel 2113i and into sample loading chamber 2103, upon opening valve 2104a, 2104b, sample also will flow from sample loading chamber 2103 to lysis chamber 2105, as described above, until equilibrium is reached within the fluidic component 2100, via displacement of air into the common expansion structure (vent pockets 2104a, 2104b, common expansion channel 2116, and common vent chamber 2130). The configuration of the sample loading chamber 2103 with the relatively sharp and narrow downstream shape that connects to the waste channel 2119i helps to prevent the sample from chamber 2103 from entering channel 2119i prior to vent pocket 2104d being opened. And with sufficient volumes of sample filling both the chambers 2103 and 2105, and equilibrium reached, upon the fluid level sensor detecting the sample in the chamber 2105 and/or after a sufficient time period has passed to ensure lysis has occurred and enough fluid is in chamber 2105, vent pocket 2104d can be opened via puncturing of the heat labile material layer 1300 at a location aligned with the vent pocket 2104d, as has been described herein. The pressure differential due to vent pocket 2104d being opened and the gravitational forces can thus allow for any excess sample that remains in chamber 2103 to flow through channel 2119i and into waste chamber 2109 as described above. The sharp and narrow downstream shape of the chamber 2103 also assists with preventing the sample from backfilling into to the chamber 2103, providing a shear force that tends to force the sample into the channel 2119i. As fluidic device 1000 does not incorporate the built-in metering, a predetermined volume of sample can initially be loaded through inlet port 1102 into the fluidic device 1000, with the predetermined volume measured in advance and selected to ensure a sufficient amount of volume for the workflow and to drive flows and reactions through the device as desired.

Once the sample has filled lysis chamber 1105, 2105 to the desired level and a sufficient amount of time has passed for the desired lysis to occur to release nucleic acid in the sample, the workflow using either fluidic device 1000, 2000 can proceed by opening vent pocket 1104c, 2104c (again by puncturing the film component 1300, 2300 as has been described) which causes gas to flow from chamber 1105 through vent channel 1116v, 2116v and sample to flow from the lysis chamber 1105, 2105 through channel 1116i, 2116i and reagent recess 1126, 2126 and into reaction chamber 1106, 2106 (also referred to as amplification chamber 1106, 2106), in which chamber a nucleic acid amplification reaction can be conducted.

The reagent recess 1126, 2126 may thus contain lyophilized reagent for performing a nucleic acid amplification reaction on the lysed sample in the amplification chamber 1106, 2106. In various embodiments, the reagent in the reagent recess 1126, 2126 may comprise one or more reagents suitable for nucleic acid amplification, and more particularly for PCR, such as, for example, suitable buffers, salt, deoxyribonucleotides, ribonucleotides, oligonucleotide primers, and enzymes, such as DNA polymerase. In various other embodiments, it is contemplated that in lieu of or in addition to reagent recesses containing reagents, reagents may be in one or more of the reaction chambers, such as via spraying and drying the reagents onto an interior surface of the reaction chamber.

Once the sample has moved to the amplification chamber 1106, 2106, the thermal generation elements of the circuit board component 1200, 2200 aligned with the amplification chamber 1126, 2126 can be controlled so as to subject the amplification chamber 1126, 2126 (and content therein) to a number of temperature cycles at specified temperature ranges, for example, in accordance with conducting a RT-PCR reaction. In various embodiments, the thermal cycling reaction can be between temperatures ranging from range of approximately 30° C. to approximately 110° C., for example from approximately 30° C. to approximately 110° C. at a rate of temperature change on the order of approximately 10° C. to approximately 50° C. per second. In various other embodiments, the temperature cycling may range from approximately 37° C. to approximately 110° C. In various embodiments, the number of cycles may range from approximately 20 cycles to approximately 50 cycles, for example from approximately 30 cycles to approximately 45 cycles. In various embodiments, by cycling over a delta temperature range (ΔT range) of approximately 15° C. or 20° C. (e.g., between annealing/extension and denaturation), reduced thermocycling times may be achieved. For example, cycling from about 75° C. for annealing/extension to about 90° C. for denaturation can provide an overall time for a number of cycles ranging from about 35-42 cycles in about 5 to about 7 minutes. In another example, by cycling from about 70° C. for annealing/extension to about 90° C. for denaturation can provide an overall time for a number of cycles ranging from about 35-42 cycles in about 6 to about 8 minutes. In some embodiments, forced air cooling may occur during the temperature cycling, in addition to control of the thermal energy generation elements to more quickly lower the temperature of the amplification chamber.

Following the substantial completion of the nucleic acid amplification in the amplification chamber 1106, 2106, which may be determined based on the overall time and number of temperature cycles which have occurred, the pocket vent 1104d, 2104e can be opened by rupture of the film component 1300, 2300, allowing gas to be displaced from chamber 1107, 2107 through vent channel 1117v, 2117v and in turn allowing the contents of amplification chamber 1106, 2106 to flow through inlet channel 1117i, 2117i through reagent recess 1127, 2127 and into chamber 1107, 2107, where an exonuclease digestion reaction can occur.

The reagent recess 1127, 2127 may thus contain lyophilized reagent for performing an exonuclease digestion reaction on the amplified sample from the amplification chamber 1106, 2106. In various embodiments, the reagent in the reagent recess 1127, 2127 may comprise one or more reagents suitable for exonuclease digestion, such as, for example, suitable buffers, salts, and exonuclease digestion enzymes. In various embodiments, the one or more reagents for exonuclease digestion include Trehalose Dihydrate, sucrose, molecular grade water, 1M Tris-HCl, 1M Ammonium Suflate, 10% Triton-X-100 Solution, Cresol Dye Solution, 50 mg/ml BSA, an highly concentrated T7 Gene 6 Exonuclease.

To conduct the exonuclease digestion reaction, the chamber 1107, 2107 can be held at an elevated temperature of about 20 degrees centigrade to about 40 degrees centigrade, for example about 40 degrees centigrade, for about 60 seconds.

After the exonuclease digestion reaction has occurred in chamber 1107, 2107, pocket vent 1104e, 2104f can be opened, again by localized rupture of film component 1300, 2300, thereby allowing gas to escape from detection chamber 1108, 2108 through vent channel 1118v, 2118v and the processed sample (with amplified nucleic acid if such analyte was in the original loaded sample) from the chamber 1107, 2107, through the inlet channel 1118i, 2118i and to the detection chamber 1108, 2108. As can be seen in the drawings, the inlet channel 1118i, 2118v opens to a capillary pool region 1108p, 2108p at the upstream portion of the detection chamber 1108, 2108. The capillary pool region 1108p, 2108p may have a volume and space of sufficient capacity to accommodate the entire volume of fluid in the detection chamber 1108, 2108 at a height that enables the fluid to contact the end of lateral flow substrate 1150 (e.g., a lateral flow strip) in the detection chamber 1108, 2108 of FIGS. 1B/2 and FIGS. 9B/10, respectively, and thereby enable flow of the sample fluid up a lateral flow substrate, such as lateral flow substrate 1150 in detection chamber 1108, 2108, respectively by capillary action without flooding or otherwise bypassing the portions of the lateral flow substrate designed to receive the fluid for desired capillary migration. In some embodiments, detection reagent are lyophilized and contained in the capillary pool region 1108p, 2108p.

In some embodiments, the detection reagent comprises one or more of dyed polystyrene microspheres, colloidal gold, semiconductor nanocrystals, or cellulose nanoparticles. The sample solution mixes with the detection reagent in the detection chamber 1108, 2108 (e.g., the capillary pool region 1108p, 2108p) and flows by capillary action up a lateral flow substrate, such as lateral flow substrate 1150 in detection chamber 1108, 2108 of FIGS. 1B/2 and FIGS. 9B/10, respectively. In various embodiments, the detection chamber 1108, 2108 may be heated (e.g., via one or more thermal energy generation elements of the circuit board component 1200, 2200 aligned with the detection chamber 1108, 2108) prior to introducing sample to the detection chamber and/or as sample migrates through the detection region of a lateral flow substrate. In an embodiment in which the lateral flow substrate includes an initial registration fiducial mark, as discussed for example with reference to FIG. 11B, a fiducial mark may be formed at a location of a capture probe region, such that the fiducial mark may disappear upon contact with the sample fluid and be replaced with a later-developing target amplicon capture probe region in the case of a positive assay result. Alternatively, the registration fiducial mark can disappear altogether with no replacement of a target amplicon capture probe region in the case of a negative assay result. In either instance, the presence of the registration fiducial mark upon initial use of the fluidic device to conduct the assay, permits an optical sensing mechanism to register the location along the later flow substrate to be recorded as the location to sense whether or not a later-developed capture probe occurs, and thus to detect that a positive or negative test result has occurred. Other locations of a registration fiducial marks may also be selected, with the control system being programmed to know and subsequently measure distances from a registration fiducial mark to a location of an analyte-capture probe region or control capture probe region so that accurate sensing and detection of test results can be implemented.

In various embodiments, a lateral flow substrate may comprise an absorbent material doped or patterned with dried or lyophilized detection reagents such as detection particles (e.g. dyed microsphere conjugates and/or colloidal gold conjugates), capture probes for the capture of analytes such as hybridization capture oligonucleotides for the capture of nucleic acid analytes by sequence specific hybridization, ligands such as biotin or streptavidin for the capture of appropriately modified analytes, and absorbent materials to provide an absorbent capacity sufficient to ensure complete migration of the sample solution volume through the lateral flow substrate where the various capture probes for detection are located, by such means as capillary action or wicking. Thus, through the labeling of the analyte amplified nucleic acid by the detection reagent in the capillary pool region 1108p, 2108p, and the specific capturing probes located on the lateral flow substrate, the target nucleic acid analyte can be captured and a detectable signal produced at a capture probe region, which can be imaged (detected) by an optical imaging device or an observer, or detectable by a fluorescence sensor, through a transparent portion of the detection chamber 1108, 2108. In an embodiment, the chamber 1108, 2108 may be heated so as to raise the temperature of the lateral flow substrate therein during hybridization. For example, the temperature of the lateral flow substrate may be heated by virtue of heating the chamber 1108, 2108 in a range of from about 27° C. to about 35° C. In some cases, the heating of the chamber 1108, and thus the lateral flow substrate, occurs over a relatively short time period so as to minimize non-specific binding from occurring.

In various embodiments, it is additionally contemplated that thermal control of the various chambers can be utilized to achieve thermally-induced pressure changes that can be effective for further driving fluid flow through the fluidic device and/or achieve mixing within chambers. For example, heating downstream chambers prior to flowing the sample from an upstream chamber and then cooling the downstream chamber timed with when it is desired to flow the sample into the downstream chamber can cause an expansion and then contraction of gas that is timed to create a pressure differential that may further assist to cause the flow of sample to the downstream chamber. Moreover, the additional force caused by this pressure differential effect on the fluid may provide some disturbances (e.g., bubbling up of gases through the chamber) to the sample in the downstream chamber that promote mixing of the sample, for example, with a reagent.

In various embodiments, the fluidic devices, such as fluidic devices 1000, 2000 may be in the form of a cassette configured for insertion into an instrument that provides the various control functionality to the circuit board component and various sensors used to control the workflows through the cassette. The cassette may be configured as a single use, disposable device or for multiple uses. One embodiment of an instrument into which fluidic devices, e.g., in the form of a cassette as disclosed herein is configured to be inserted is illustrated in FIGS. 12-18.

### Instrument

As mentioned above, in some embodiments it is desirable to place electronic components, such as various sensors, light sources, electrical connectors, power sources, etc. in a reusable component such that one or more of heaters, sensors, light sources, and other electronics, are interfaced to the fluidic device (such as a disposable cassette) by a means capable of establishing a favorable thermal interface and accurate registration of electronics with overlying elements of the fluidic device with which they must interface. In other embodiments it is desirable to use a combination of reusable and disposable components for temperature control. For example, stand-off temperature monitoring can be accomplished with infrared sensors placed in a reusable instrument, while resistive heaters for temperature control and fluidics control are placed in a flexible circuit integrated into the fluidics device, for example in circuit board component 1200, 2200 of fluidic devices 1000, 2000, for example of FIG. 1B and FIG. 9B, described above. It is further envisioned that such an instrument configured to cooperate and interact with a fluidic device may include one or more memory devices and processors (e.g., microprocessors) so that executable instructions can be carried out to control the timing of workflow operations such as heating of chambers of the fluidic devices, rupturing of vents, sensing of information and results of assays and other processes occurring in the fluidic device to accomplish a desired workflow.

The microcontroller(s) can be matched to the complexity of the fluidic device. For example, with multiplexing, the number of individual vents and heaters is commensurate with the number of microcontroller I/O lines. Memory size can be chosen to accommodate program size. In certain embodiments of the invention, N-channel MOSFETs may operated in an ON-OFF mode to modulate current load to vent and heater resistors. Modulation signals may be sent via the microcontroller. In alternative embodiments, a pulse-width-modulation scheme and/or other control algorithms could be used for more advanced thermal management of fluidics. This would typically be handled by the microcontroller and may require additional hardware and/or software features known to those skilled in the art.

With reference now to FIGS. 12-18, one embodiment of an instrument configured to receive a fluidic device, such as fluidic device 1000 or 2000, and which may be in the form of a cassette, which may be disposable in various embodiments, is illustrated and will be described. FIG. 12 illustrates a front right perspective view of the instrument 5500 (front herein refers to the side of the instrument with the display), which comprises Instrument housing 5510 defining base portion 5512, a front face comprising a display 5515, and a fluidic device (e.g., cassette) insertion portion 5520. The display 5515 may be an LCD display in one embodiment and may communicate information such as workflow (assay) protocols and status to a user. In an embodiment, the display 5515 may be a touchscreen display and configured to accept user input, for example, to provide control parameters for workflows to be carried out. The instrument 5500 also comprises one or more external connector interfaces 5530 (one being shown in FIG. 12) that may be configured to connect to various transmission conduits, such as electrical transmission conducts so as to transmit power from an external power source to the instrument 5500, data transmission conduits to transmit data, and/or combined conduits to transmit power and data to various devices, such as peripheral devices including printers, monitors, etc., and/or to networked computing device and/or telecommunications devices.

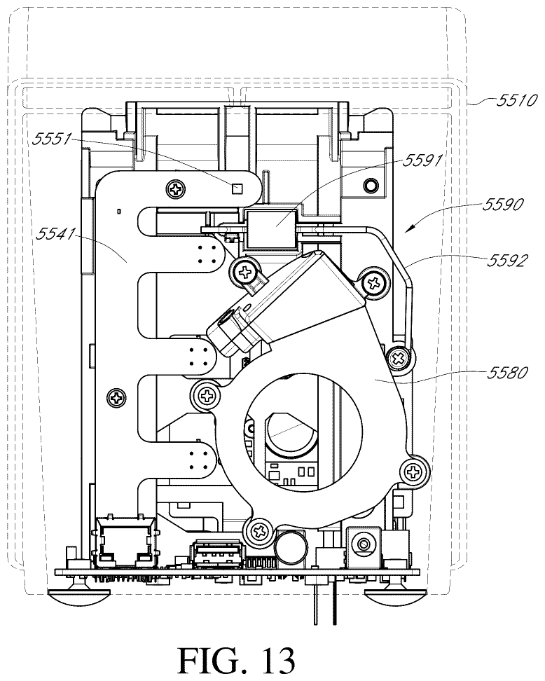

The fluidic device insertion portion 5520 comprises an aperture 5521 configured to receive a fluidic device, such as fluidic device 1000 or 2000, and permit cooperation of the fluidic device in a desired manner in the interior of Instrument housing 5510 so as to situate the fluidic device in registration with various components located in the interior of Instrument housing 5510, as further described below with reference to FIGS. 13-18. The aperture 5521 may have dimensions that provide a tight tolerance with the fluidic device to ensure proper insertion and a secure fit when inserted into the instrument 5500. Optionally, as reflected in the embodiment of FIGS. 12-18, the fluidic device insertion portion 5520 can provide a surface profile surrounding the aperture 5521 that provides a lead-in to the aperture 5521 to help guide the fluidic device during insertion. For example, the surface profile 5522 of the fluidic device insertion portion 5522 surrounding the aperture 5521 may have a generally funnel-shaped configuration.

Insertion of the fluidic device cassette into the instrument 5500 through aperture 5521 places the fluidic device in an orientation and positioning that permits various portions of the instrument 5500 to interact with the fluidic device. For example, in an inserted position in the instrument 5500, the fluidic device is placed in a desired positioning for various sensors to obtain data from the fluidic device, such as for thermal control, fluidics flow handling, monitoring of portions of an overall workflow, and detection of test results. In addition, the fluidic device is placed in electrical communication with a printed circuit assembly of the instrument so as to provide the transmission of current to the various addressable thermal energy generation elements and other control elements of the circuit board component of the fluidic device.

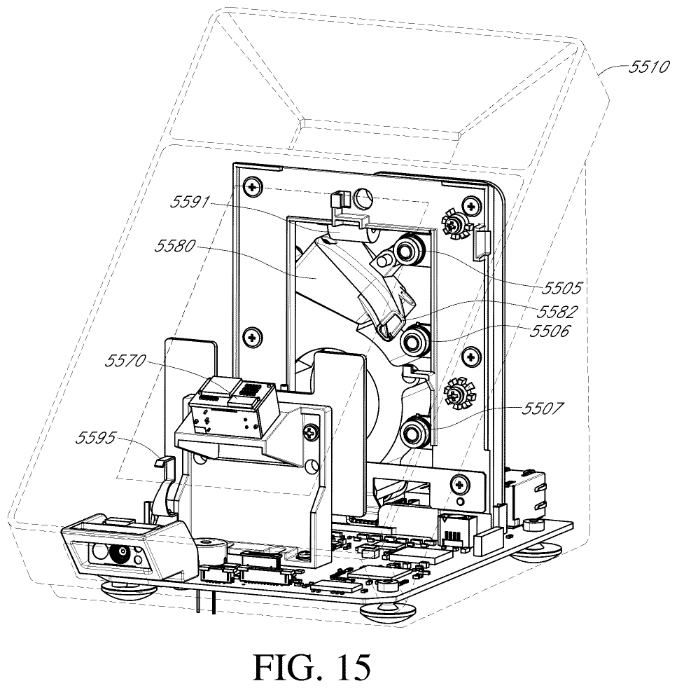

To provide enhanced thermal and fluidics control during use of a fluidic device to perform a workflow involving temperature changes occurring in one or more reaction chambers of the fluidic device, the instrument 5500 includes various temperature sensing mechanisms to monitor the temperatures occurring in various chambers of the fluidic device. In the embodiment of the instrument of FIGS. 12-18, temperature sensing mechanisms are provided that enable temperature sensing of each of three general regions of a fluidic device inserted in the instrument. For example, in the case of fluidic device 1000 or 2000 received in the instrument 5500, temperature sensing is provided for regions associated with each of the reaction chambers 1105, 1106, 1107, 2105, 2106, 2107. FIG. 15, is a front perspective view that illustrates generally Instrument housing 5510 shown in phantom and front sensor mounting plate 5542 of FIG. 17 removed to show components behind the plate. As depicted in FIG. 15, temperature sensing mechanisms comprising infrared (IR) temperature sensors 5505, 5506, 5507 are positioned generally along an insertion axis (or parallel thereto) of a fluidic device into the instrument 5500 and so as to align generally with each of the respective reaction chambers 1105, 2105, 1106, 2106, 1107, 2107 in an inserted position of fluidic devices 1000, 2000. The IR temperature sensors allow for noncontact monitoring of the temperatures occurring in each of the reaction chambers with feedback to the instrument microcontroller. The IR temperature sensors 5505, 5506, 5507 are positioned to be disposed on the circuit board component side of the fluidic device in the inserted position of the fluidic device in the instrument 5500.

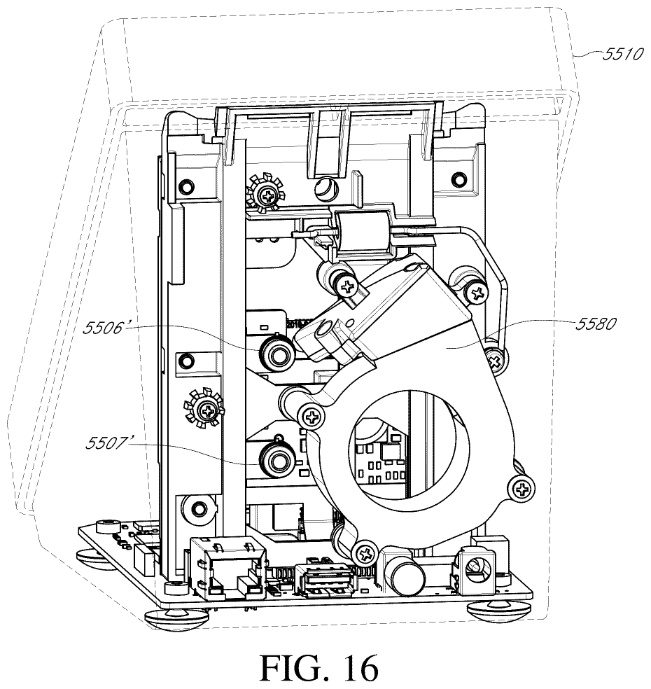

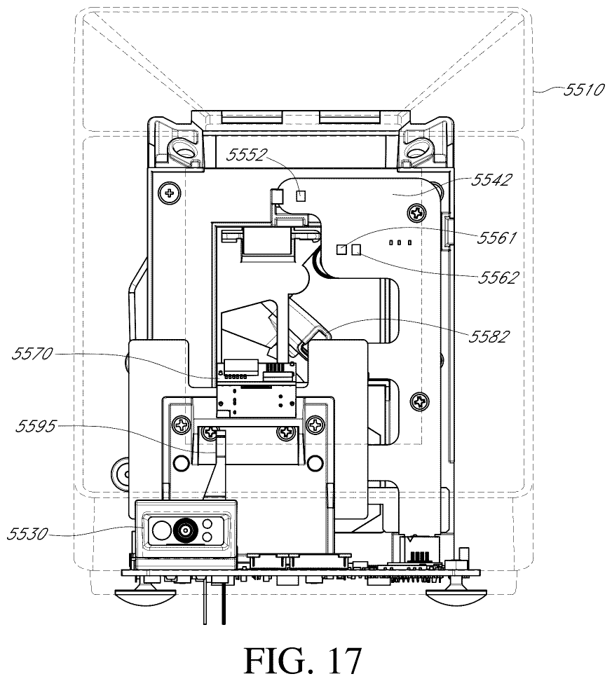

In some embodiments, it is contemplated that a set of IR temperature sensors can be associated with a reaction chamber so as to provide more accurate temperature sensing. For example, f FIG. 16 is a back perspective view that illustrates generally interior components within the Instrument housing 5510 shown in phantom and a back sensor mounting plate 5541 of FIG. 13 removed so as to see various components located toward the front of Instrument housing 5510. As depicted in FIG. 16, IR temperature sensors 5506′, 5507′ can be positioned in a generally opposed relationship with IR temperature sensors 5506, 5507, respectively. In this way, when the fluidic device 1000, 2000 is inserted in the instrument, temperature may be sensed from both sides of the reaction chambers 1106, 2106, 1107, 2107 the fluidic device 1000, 2000, permitting the ability to monitor how fast heat is moving through the chamber, which can be useful to know given the chambers are heated from the side of the fluidic device associated with the circuit component. In other words the fluidic device 1000, 2000 in the inserted position in instrument 5500 is situated between the opposing sets of IR temperature sensors 5506, 5506′ and 5507, 5507′ so that the temperature of each of chambers 1106, 2106, 1107, 2107 can be respectively monitored from opposite sides of the fluidic device 1000, 2000. Providing such temperature sensing from both sides of a reaction chamber can provide more accurate monitoring of the temperature in the associated reaction chamber, as well as providing information as to the uniformity of the temperature in the chamber. This may be desirable when monitoring temperature-sensitive reactions occurring in a chamber and/or chambers undergoing multiple temperature changes, such as, for example chambers supporting thermal cycling reactions such as, for example, PCR. While one example of a workflow in which PCR is conducted in chambers 1106, 2106 of fluidic devices 1000, 2000 has been described, providing a set of IR temperatures sensors associated with both chambers 1106, 2106, and 1107, 2107 can make the instrument more flexible to use for differing workflows with which the fluidic devices 1000, 2000 may be designed to carry out. For example, a thermal cycling or other reaction for which more precise temperature control may be desired can be carried out in either or both of the chambers 1106, 2106, 1107, 2107. Moreover, while IR temperature sensors are shown in the instrument 5500, other types of temperature sensors could also be used, such as, for example, thermistors, without departing from the scope of the present disclosure. Additionally, a processor can receive temperature information from a pair of opposing infrared sensors and based at least partially on the temperature information, determine a rate of thermal energy change in the reaction chamber.

For example, in conjunction with utilizing a fluidic device such as fluidic devices 1000, 2000, one implementation of a workflow that coordinates heating and subsequent cooling of a downstream chamber with the timing of opening a vent pocket fluidically coupled to that chamber to enhance fluid flow from an upstream chamber to the downstream chamber will now be described with reference to chamber 1106, 2106 as the downstream chamber and chamber 1105, 2105 as the upstream chamber. In one example workflow, when it is desired to flow the contents of chamber 1105, 2105 to the chambers 1106, 2106, the chamber 1106, 2106 can be heated, via the thermal energy generation element associated with the chamber 1106, 2106, to 90° C. for 1.5 seconds. Such heating results in expansion of the gas (e.g., air) in chamber 1106, 2106, causing gas bubbles up through the channel 1116i, 2116i into the fluid contents in the chamber 1105, 2105 until the pressure equalizes above and below the fluid in chamber 1105, 2105. After heating, the thermal energy generation element associated with the chamber 1106, 2106 can be deactivated and the chamber 1106, 2106 cooled, such as via blowing of air across the chamber 1106, 2106. In an embodiment, the air can be blown by a fan that is incorporated into an instrument controlling the other electronics and circuitry as has been described, with one embodiment of such an instrument being described with reference to FIGS. 12-18, and more particularly with reference to FIGS. 13, 15, and 16 showing the fan. The cooling can occur for time period of 2 seconds. The cooling causes the gas in the chamber 1106, 2106 and in the channel 1116i, 2116i to contract, creating a suction force on the fluid contents in the upstream chamber 1105, 2105, which force tends to overcome the surface tension acting on the fluid contents from the walls of the chamber 1105, 2105 and the entrance to the channels 1116i, 2116i. This suction force thus assists the gravitational force that acts on the fluid upon opening of the vent pocket 1104c, 2104c. After cooling for 2 seconds, the vent pocket 1104c, 2104c can be opened by rupturing the film component at the locations of the vent pocket 1104c, 2104c, which allows the gas from chamber 1106, 2106 to be released through vent channel 1116v, 2116v, creating a pressure differential that further drives the fluid from chamber 1105, 2105 to chamber 1106, 2106. The fluid contents of 1105, 2105 are thus flowed into chamber 1106, 2106 until air pressure builds up in the channel 1117i, 2117i. This process of fully emptying the contents of the upstream chamber 1105, 2105 into the downstream chamber 1106, 2106 occurs over a time period of about 3 seconds, after which time period the cooling of the chamber 1106, 2106 can be stopped (e.g., the fan can be turned off), allowing the subsequent reaction, and coordinated thermal control supporting such reaction, in chamber 1106, 2106 to occur.

While the above description referenced the chambers 1105, 2105 and 1106, 2106, other chambers could be controlled accordingly to achieve the same effect, such as, but not limited to, for example, when it is desired to move fluid contents from chamber 1106, 2106, to chamber 1107, 2107 in the embodiments of the fluidic devices 1000, 2000. Moreover, the above time and temperature ranges are by way of non-limiting example, and depending on the configurations of various chambers and/or the fluidic layer structures, other temperatures and time periods may be more suitable. In one implementation, it is desirable to control the time/temperature of heating of a downstream chamber in a manner that avoids fluid in the upstream chamber being displaced into an inlet channel to that chamber, which can occur if the gas expansion and bubbling of the fluid contents caused by gas expansion is too vigorous.

In the embodiment of instrument 5500, the IR temperature sensor 5505 does not have an opposing sensor. This is because it is contemplated to use the sensor 5505 as a mechanism for monitoring that liquid has flowed into the corresponding region of an inserted fluidic device and a workflow has begun (e.g., based on the flow of fluid through a fluidic device in a generally gravity-driven manner from the upper regions of a device to the lower regions). Such monitoring for liquid filling the chamber does not need the overall accuracy or sensitivity that may be needed when monitoring the temperatures of reactions that are occurring in a chamber and thus a single temperature sensor can be used. In an embodiment of fluidic device 1000, 2000 being inserted in the instrument 5500, for example, the IR sensor 5505 may be located to sense a temperature of the reaction chamber 1105, 2105, which may be used for lysis for example in accordance with the workflow described above. Instead of an IR sensor, it is contemplated that a thermistor could be used and the power monitored so as to determine indirectly the temperature in the chamber. has decreased due to filling it with liquid.

The various IR temperature sensors 5505, 5506, and 5507 can be mounted on a common mounting plate 5541 (also referred to as a back sensor mounting plate), seen from the back in the back plan view of FIG. 13. Likewise, the IR temperature sensors 5506′, 5507′ can be mounted on a common mounting plate 5542 (also referred to as a front sensor mounting plate) generally opposing mounting plate 5541 and seen from the back in the front plan view of FIG. 17.

Other sensors for providing information to assist with fluidic flow control which are included in the instrument 5500 include the sensor used in conjunction with the optical manipulation feature of the fluidic device 1000, 2000 to assist with liquid level sensing and a transmitter/receiver sensing mechanism for sensing the insertion of a pipette or other sample delivery tool inserted into the fluidic device 1000, 2000. With regard to the latter, and with reference to FIGS. 13 and 17, a light transmitter/receiver sensing mechanism 5551, 5552 is placed proximate to where a pipette or other sample delivery device is inserted into the fluidic device positioned in the instrument 1000 such that when light from the transmitter is blocked due to insertion of the pipette, the receiver will no longer received the transmitted light and can thus detect the presence of the pipette. In some cases, this can be used as a trigger to set off timing and sensing of the workflow to follow The instrument 5500 can further include the transmitter and receiver sensing devices 5561, 5562, shown in FIG. 17, used as part of the fluid level sensing in conjunction with the optical manipulation feature of the fluidic devices 1000, 2000, as described above with reference to FIGS. 7A and 7B for example.

Regarding fluid level sensing as previously described herein for FIG. 7A and FIG. 7B, the instrument 5500 can use the transmitter 5561 to transmit the light toward the lysis chamber 1105, 2105 and optical manipulation surface feature 1122, 2122 of a fluidic device 1000, 2000 inserted into the instrument 5500 and the received 5562 to receive the signal (if any) reflected back to sense whether or not the chamber 1105, 2105 is filled with a fluid of interest (e.g., sample for analysis). As can be seen from FIGS. 13 and 17, the various transmitter and receiver sensing mechanisms 5551, 5552, 5561, 5562 can be mounted on the mounting plates 5541, 5542. Additionally, a processor can receive information from sensor regarding the light detected and determine if liquid is covering the location of the surface feature of a fluidic device based at least partially on the information received.

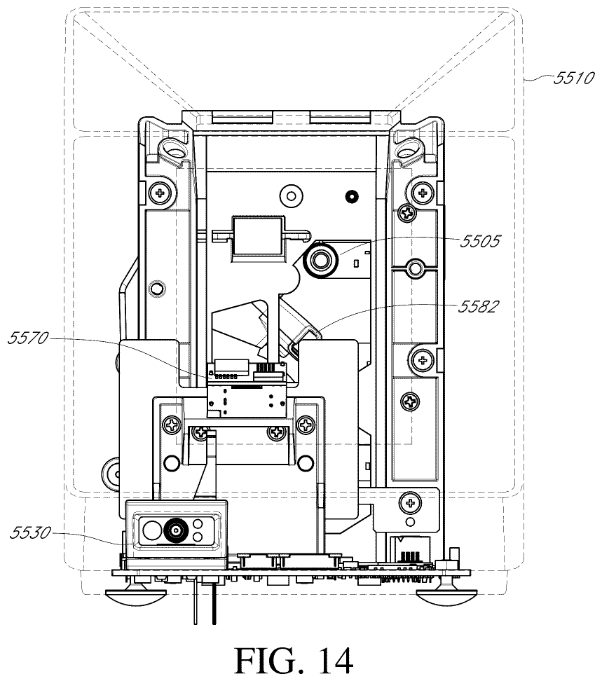

With reference now to FIGS. 14, 15, and 18, the instrument 5500 further includes an image capture system 5570 for capturing images of a lateral flow substrate of an inserted fluidic device, such as fluidic devices 1000, 2000, for example of FIG. 1A-FIG. 2 and FIG. 9A-FIG. 10. The image capture system 5570 comprises a light source, such as an LED light source, a digital image capture component, such as a CMOS or CCD based image capture device, and one or more optical elements, such as one or more filters, lenses, and the like, to provide high resolution digital image capturing of a lateral flow substrate of a fluidic device, such as lateral flow substrate 1150 of FIGS. 1B/2 and FIGS. 9B/10, respectively. This allows for the detection results to be analyzed by a microprocessor with corresponding results displayed to the display 5515. Further, collected detection images can be stored into memory within the instrument where result interpretation can be accomplished using an on-board processor and reported to the display 5515 and/or otherwise output to external peripheral devices and data acquisition software.

For example, image capture system 5570 can capture image data of a lateral flow substrate of a fluidic device, such as fluidic device 1000 of FIG. 1A through FIG. 3 and fluidic device 2000 of FIG. 9A through FIG. 10. Accordingly, a processor can receive a first set of captured image data of the lateral flow substrate before a biological assay is conducted, in which the first set of captured image data includes an image of fiducial marks on the lateral flow substrate. During or after the biological assay has been conducted, the process can receive a second set of capture image data of the lateral flow substrate, and the processor can process the first and second set of captured image data to generate processed data. Information can then be output regarding the presence or absence of a target analyte in the biological assay conducted based on the processed data.

In an embodiment, the light source may be a ring of LEDs so as to provide uniform illumination during image collection with a CMOS-based digital camera. Images collected with the device can provide high-resolution data (5 megapixels, 10 bit) suitable for signal analysis. Optionally, digitized results may be transmitted for off-line analysis, storage and/or visualization via a wireless communication system incorporated into the docking unit employing either standard WiFi or cellular communications networks.

As mentioned above and as best seen in FIGS. 13-18, cooling of the instrument can be accomplished using a blower 5580, such as a muffin style fan, which can be turned on and off by the microcontroller. The blower may have an outlet 5582 to direct the air from the blower 5580 toward a location of where a reaction chamber of a fluidic device is located during use of the instrument 5500 to conduct an assay. For example, in the case of fluidic device 1000, 2000 inserted, the outlet 5582 may be directed to direct air from the blower 5580 toward the reaction chambers 1106, 2106 intended to conduct thermal cycling (e.g., PCR). In an embodiment, the blower 5580 may be controlled to blow air only during the cooling phase of the thermal cycling.

Because the electrical circuit component of a fluidic device inserted into the instrument 5500 is exposed static electricity can build up on the fluidic device and can potentially be discharged during insertion of the fluidic device into the instrument 5500. Because the instrument 5500 and fluidic device include sensitive electrical components that can be damaged and/or short if an inserted fluidic device discharges static electricity, various embodiments contemplate a mechanism for discharging any static electricity from a fluidic device inserted in the instrument. With reference to FIGS. 13-17, to accomplish such static electricity discharge, instrument 5500 includes an electrostatic discharge device 5590 comprising a contact member in the form of a roller 5591 situated near the insertion aperture 5521 and mounted on a spring arm 5592 such that the roller 5590 is biased toward the front side of the instrument 5500. The roller 5590 is configured to contact and roll against a fluidic device (e.g., fluidic device 1000, 2000) as it is inserted into the instrument 5500 through the insertion aperture 5521. A grounding cable (not shown) can be connected to the roller or spring arm and grounded to, for example, an instrument housing, such as Instrument housing 5510 of FIG. 12, to safely ground any static electricity that is discharged from the fluidic device. The roller 5591 is one embodiment of an electrostatic discharge device and other embodiments are also contemplated as within the scope of the present disclosure. Suitable other electrostatic discharge devices can be one or more metallic (e.g., copper) threads situated proximate the aperture 5521 in a position to make contact with the fluidic device during insertion or a conductive frame element arranged to make contact with the fluidic device during insertion.

To further protect against electrostatic discharge in the instrument, the instrument 5500 also includes an electrical grounding member 5595, shown best in FIGS. 15 and 17, to electrically ground the touchscreen display.

The instrument 5500 also may include an optical sensing device that is configured to read a barcode from both external and internal the instrument 5500. An external optical sensor may read, for example, a barcode (or QR code) associated with personnel, or be configured to sense biometric identification data of individuals authorized to use the instrument. An internal optical sensing device may also be employed to sense a barcode, QR code, or other similar sensible component on a fluidic device and based on the same the microcontroller can be programmed to determine the type of fluidic device (e.g., the contents of reagents, layout of the device, and other parameters for carrying out a desired assay) and/or to confirm complete insertion and correct seating of the test cassette. The instrument 5500, via the optical sensing device, may also read a barcode, QR code or other sensible code on the fluidic device and change its programming in accordance with stored programs for different assays and/or the barcode or QR code itself can encode different parameters of the assay and instruct the instrument 5500 accordingly. In an embodiment, the external optical sensing device may be collocated with the connector interface 5530.

It is to be understood that both the foregoing general description and the following detailed description are exemplary and explanatory only and are not restrictive of the present disclosure and claims, including equivalents. It should be understood the present disclosure and claims, in their broadest sense, could be practiced without having one or more features of these exemplary aspects and embodiments. For example, the following detailed description related to various devices, systems, and methods to perform PCR amplification, labeling, and lateral flow detection a biological sample analyte is exemplary only, and the disclosed devices, systems, and methods can have various components and include other steps that are integrated into part of an overall system for sample processing and analysis, such as for example, various devices, systems, and or methods that are implemented with initial sample preparation and/or analysis via polymerase chain reaction or other nucleic acid amplification and/or sequencing reactions, and/or protein analysis.

For example, other modifications to structure, arrangements, methods, materials and the like may be made without departing from the scope of the present disclosure and principles of operation. By way of example, while various embodiments describe a workflow for which fluidic devices as described herein may be used to perform amplification of target nucleic acid, amplification assays other than PCR may be implemented, including, for example, isothermal amplification (e.g., loop-mediated isothermal amplification (LAMP)), strand displacement amplification, rolling circle amplification, and other such amplification assays. Moreover, while various embodiments depict reagent recesses that contain lyophilized reagent, reagents could instead or in addition be placed within one or more of the reaction chambers of the fluidic component, within channels of the fluidic component, or added with the sample. Lyophilized reagent within the device can be in the form of beads or other particulates, sprayed on surfaces and dried, etc.

As such, according to the present disclosure, in a first example of a fluidic device for conducting a biological assay, the fluidic device comprises a fluidic component defining a fluidic network, the fluidic network comprising a reaction chamber and a detection chamber including a lateral flow substrate, a circuit board component configured to align a thermal energy generation element with the reaction chamber, and one or more thermally insulative portions adjacent a perimeter of the reaction chamber.

In a second example of a fluidic device for conducting a biological assay, the fluidic device comprises a fluidic component defining a fluidic network comprising a plurality of chambers, as well as a surface feature located proximate at least one chamber of the plurality of chambers, the surface feature configured to manipulate light transmitted toward the surface feature in differing patterns based on a substance in the at least one chamber of the plurality of chambers covering a location of the surface feature.

A third example includes the subject matter of the second example, and further specifies that the at least one chamber of the plurality of chambers comprises a reaction chamber and a detection chamber; the detection chamber including a lateral flow substrate, said lateral flow substrate comprising at least one capture probe region including one or more reagents configured to react with a sample of detection-probe labeled amplicons to provide a detectable signal at the capture probe region in response to the reaction, and a fiducial mark present on the at least one capture probe region, wherein the fiducial mark is configured for detection calibration.

A forth example includes the subject matter of any of the second and third examples and further includes a circuit board component configured to align a thermal energy generation element with the reaction chamber, and one or more thermally insulative portions adjacent a perimeter of the at least one chamber of the plurality of chambers.

A fifth example includes the subject matter of any of examples 2-4, and further specifies that the surface feature is configured to reflect the transmitted light based on air in the at least one chamber covering a location of the surface feature.

A sixth includes the subject matter of any of examples 2-5, and further specifies that the surface feature is a first surface feature and another wall portion of the fluidic component adjacent and outside a perimeter of the at least one chamber further defines a second surface feature positioned to intercept light reflected from the first surface feature and reflect the light in a direction opposite to a direction of the transmitted light toward the first surface feature.

A seventh example includes the subject matter of the sixth example, and further specifies that the first surface feature and the second surface feature define an angled recess in an interior wall surface of the fluidic component defining the at least one chamber.

An eight example includes the subject matter of any of examples 2-7, and further specifies that the surface feature is configured to transmit the transmitted light into the at least one chamber based on a liquid in the at least one chamber covering a location of the surface feature.

A ninth example includes the subject matter of any of examples 3-8, and further specifies that the fiducial mark is configured to disappear upon an aqueous substance contacting the fiducial mark.

A tenth example includes the subject matter of any of examples 3-9, and further specifies that at least one chamber of the plurality of chambers comprises a metering chamber.

An eleventh example includes the subject matter of any of examples 3-10, and further specifies that the fiducial mark is configured to be sensed by an imaging device.

A twelfth example includes the subject matter of any of examples 1-11, and further specifies that the one or more thermally insulative portions comprise air gaps in the fluidic component.

A thirteenth example includes the subject matter of any of examples 1-12, and further specifies that the fluidic component has a longitudinal dimension and a lateral dimension, and a thickness dimension perpendicular to the longitudinal and lateral dimensions, and wherein the one or more thermally insulative portions comprise air gaps that are cored out portions through the thickness of the fluidic component.

A fourteenth example includes the subject matter of any of examples claim 1-13, and further specifies that the one or more thermally insulative portions comprise a material having a lower thermal conductivity than a material of the fluidic component defining the fluidic network.

A fifteenth example includes the subject matter of any of examples 1-14, wherein the one or more thermally insulative portions are regions of the fluidic component of reduced thickness relative to the thickness dimension of the fluidic component.

A sixteenth example includes the subject matter of any of examples 1 and 3-15, and further specifies that the reaction chamber is a first reaction chamber and the fluidic network further comprises a second reaction chamber, and one or more additional thermally insulative portions adjacent a perimeter of the second reaction chamber.

A seventeenth example includes the subject matter of any of examples 1 and 3-16, and further specifies that the reaction chamber has a pair of opposing longitudinal sides and the one or more thermally insulative portions comprise two portions respectively disposed adjacent each opposing longitudinal side of the pair of opposing longitudinal sides.

An eighteen example includes the subject matter of any of examples 1 and 3-17, and further specifies that the perimeter of the reaction chamber comprises two opposing longitudinal sides and two opposing lateral sides, and wherein the one or more thermally insulative portions comprise at least three portions respectively disposed adjacent differing sides of the perimeter.

A nineteenth example includes the subject matter of the eighteenth example, and further specifies that the one or more thermally insulative portions comprise four portions respectively disposed adjacent each of the two opposing longitudinal sides and the two opposing lateral sides.

A twentieth example includes the subject matter of any of examples 1 and 3-19, and further specifies that the one or more thermally insulative portions are selected to minimize an overall time to complete thermal cycling for a nucleic acid amplification reaction in the reaction chamber.

A twenty first example includes the subject matter of any of examples 1 and 4-20, and further specifies that the circuit board component is configured to align a thermal energy generation element with a heat-labile material.

A twenty second example includes the subject matter of any of examples 1 and 4-21, and further specifies that the circuit board component is a flexible circuit board.

A twenty third example includes the subject matter of any of examples 1-22, and further specifies that the fluidic device is configured to flow fluid through the fluidic network in response to gravitational force and ambient pressure force in an orientation of the fluidic device whereby the gravitational force acts along a longitudinal dimension of the fluidic component.

A twenty fourth example includes the subject matter of any of examples 1-23, and further specifies that the fluidic network further comprises one or more vent pockets in fluidic communication with one or more of the plurality of chambers, and a heat labile material sealing the one or more vent pockets.

In a twenty fifth example, a fluidic device for conducting a biological assay comprises a fluidic component defining a fluidic network comprising a plurality of chambers, the chambers including a reaction chamber, and a detection chamber including a lateral flow substrate, wherein a thickness of an end wall of the reaction chamber is less than a thickness of portions of the fluidic component adjacent a perimeter of the reaction chamber.

A twenty sixth example includes the subject matter of the twenty fifth example, and further specifies that the thickness of the end wall is between 0.51 mm to about 1.02 mm.

A twenty seventh example includes the subject matter of any of examples 25 or 26, and further includes a circuit board component configured to align a thermal energy generation element with the reaction chamber.

A twenty eighth example includes the subject matter of any of examples 25-27, and further specifies that the fluidic network further comprises one or more vent pockets in fluidic communication with one or more of the plurality of chambers, and a heat labile material sealing the one or more vent pockets.

A twenty ninth example includes the subject matter of any of examples 25-28, and further specifies that the reaction chamber is a first reaction chamber and the fluidic network further comprises a second reaction chamber downstream of the first reaction chamber, and wherein the fluidic component further comprises a first reagent configured to support an amplification reaction and to be loaded into the first reaction chamber and a second reagent configured to be loaded into the second reaction chamber and to support an exonuclease digestion reaction.

A thirtieth example includes the subject matter the twenty ninth example, and further specifies that the second reagent comprises a formulation of T7 Gene 6 exonuclease.

A thirty first example includes the subject matter of any of examples 27-30, and further specifies that the circuit board component is configured to align a thermal energy generation element with the heat labile material.

A thirty second example includes the subject matter of any of examples 25-31, and further specifies that the fluidic network further comprises one or more polymerase chain reaction reagents.

A thirty third example includes the subject matter of any of examples 25-32, and further specifies that the fluidic device is configured to flow fluid through the fluidic network in response to gravitational force and ambient pressure force in an orientation of the fluidic device whereby the gravitational force acts along a longitudinal dimension of the fluidic component.

A thirty forth example includes the subject matter of any of examples 25-33,
wherein the fluidic component has a longitudinal dimension and a lateral dimension, and a thickness dimension perpendicular to the longitudinal and lateral dimensions,
wherein the lateral flow substrate has a length extending along the longitudinal dimension of the fluidic component, and
wherein the fluidic network is configured to introduce fluid to the lateral flow substrate such that the fluid travels via capillary force along the length of the lateral flow region in a direction opposite a direction in which the gravitational force acts in the orientation of the fluidic component in which the gravitational force acts in the longitudinal dimension.

A thirty fifth example includes the subject matter of any of examples 25-34, and further specifies that the fluidic component further comprises reagent configured to be loaded into the reaction chamber to support a thermal cycling PCR in the reaction chamber.

In a thirty sixth example, a system comprises a fluidic device of any of examples 2-24, a source of light configured to transmit light along a first path in a direction toward the surface feature, and a sensor configured to detect light transmitted along a second path in a direction away from the at least one chamber.

In a thirty seventh example, a method of discharging static electricity from a fluidic device for performing a biological assay comprises inserting of a fluidic device into an instrument comprising an electronic interface configured to electrically couple with a circuit board component of the fluidic device, and while inserting the fluidic device, contacting the circuit board component with a contact member configured to discharge electrostatic energy.

In a thirty eighth example, an instrument for conducting a biological assay comprises a housing comprising an interior configured to removably receive a fluidic device configured to conduct the biological assay; and a contact member disposed in the interior, the contact member configured to contact the fluidic device during insertion into the housing interior and discharge electrostatic electricity.

A thirty ninth example includes the subject matter of the thirty eighth example, and further includes an electrically conductive grounding member electrically coupled to the contact member and to the housing.

A fortieth example includes the subject matter of any of examples 38 or 39, and further includes a biasing member coupling the contact member to the housing, the biasing member configured to exert a biasing force on the contact member.

A forty first examples includes the subject matter of any of examples 38-40, and further specifies that the contact member is a roller.

A forty second example includes the subject matter of any of examples 38-41, and further specifies that the fluidic device comprises a circuit board component, and wherein the contact member is arranged to contact the circuit board component of the fluidic device in a state of the fluidic device being moved along the insertion axis.

A forty third example includes the subject matter of any of examples 38-42, and further specifies that the fluidic device comprises the fluidic device of any of examples 1-35.

In a forty forth example, an instrument for conducting a biological assay comprises a housing comprising an interior configured to removably receive a fluidic device, the fluidic device comprising one or more chambers and configured to conduct the biological assay, a pair of opposing infrared sensors located in a position aligned with one of the one or more chambers in a state of the fluidic device received in the interior, a first of the pair of opposing infrared sensors located on a first side of the fluidic device and a second of the pair of opposing infrared sensors located on a second side of the fluidic device, and a processor configured to receive temperature information from the pair of opposing infrared sensors and determine a rate of thermal energy change in the chamber based at least partially on the temperature information.

In a forty fifth example, an instrument for conducting a biological assay comprises a housing defining an interior configured to removably receive a fluidic device along an insertion axis, said fluidic device configured to conduct the biological assay, a plurality of infrared sensors located to sense infrared energy within the housing, a first pair of infrared sensor at a second distal to the first location and along the insertion axis, wherein the first pair of infrared sensors face each, and a second pair of infrared sensors at a third location, distal to the second location and along the insertion axis, wherein the second pair of infrared sensors face each other.

In a forty sixth example, an instrument for conducting a biological assay comprises a housing comprising an interior configured to removably receive a fluidic device configured to conduct the biological assay; a source of light configured to transmit light along a first path toward a location of a fluidic device inserted in the interior, a sensor configured to detect light from the source transmitted from the location along a second path, and a processor configured to receive information from the sensor regarding the light detected and determine if liquid has reached a predetermined level in the fluidic device based at least partially on the information.

In a forty seventh example, an instrument for conducting a biological assay comprises a housing comprising an interior configured to removably receive a fluidic device configured to conduct the biological assay, an image sensing system configured to capture of a lateral flow substrate of the fluidic device inserted in the interior, and a processor that is configured to receive a first set of captured image data before the biological assay is conducted, the first captured image data comprising an image of a fiducial mark on the lateral flow substrate, receive a second set of captured image data comprising an image of the lateral flow substrate during or after the biological assay is conducted, process the first and second captured image data to generate processed data, and output information regarding the presence or absence of a target analyte in the biological assay based on the processed data.

A forty eighth example includes the subject matter of the forty seventh example, and further specifies that the image capture system comprises a digital image capture device.

A forty ninth example includes the subject matter of the forty eighth example, and further specifies that digital image capture device comprises a CMOS device.

A fiftieth example includes the subject matter of any of examples 38-49, and further includes an aperture leading to the interior, the aperture configured to permit removable insertion of the fluidic device into the interior.

A fifty first example includes the subject matter of any of examples 38-50, and further includes an electronic interface configured to electrically couple with one or more electrical components of the fluidic device in a state of the fluidic device received in the interior.

A fifty second example includes the subject matter of any of examples 44-51, and further includes a contact member disposed in the interior, the contact member configured to contact the fluidic device during insertion into the housing interior and discharge electrostatic electricity.

In a fifty third example, a system for conducting a biological assay comprises a fluidic device of any of claims 1-35; and an instrument comprising a housing defining an interior configured to removably receive the fluidic device, a pair of opposing infrared sensors located in a position aligned with a reaction chamber of the fluidic device, wherein a first infrared sensor of the pair of opposing infrared sensors is located on a first side of a reaction chamber and wherein a second infrared sensor of the pair of opposing infrared sensors is located on a second side of the reaction chamber, and a processor configured to receive temperature information from the pair of opposing infrared sensors and based at least partially on the temperature information determine a rate of thermal energy change in the reaction chamber.

A fifty forth example includes the subject matter of the fifty third example, wherein the instrument further comprises one or more of an aperture leading to the interior, the aperture configured to permit removable insertion of the fluidic device into the interior, a source of light configured to transmit light along a first path toward the location of the fluidic device inserted in the interior, a sensor configured to detect light from the source transmitted from the location along a second path, and a processor configured to receive information from the sensor regarding the light detected and determine if liquid is covering the location of the surface feature of the fluidic device based at least partially on the information.

A fifty fifth example includes the subject matter of examples 53 or 54, wherein the instrument further comprises a contact member disposed in the interior, the contact member configured to contact the fluidic device during insertion into the housing interior and discharge electrostatic electricity from the fluidic device.

A fifty sixth example includes the subject matter of any of examples claims 53-55, wherein the instrument further comprises an image capture system configured to capture image data of a lateral flow substrate of the fluidic device inserted in the interior and wherein the processor is further configured to receive a first set of captured image data of the lateral flow substrate before the biological assay is conducted, the first set of captured image data comprising an image of a fiducial mark on the lateral flow substrate, receive a second set of captured image data comprising an image of the lateral flow substrate during or after the biological assay is conducted, process the first and second set of captured image data to generate processed data, and output information regarding the presence or absence of a target analyte in the biological assay based on the processed data.

While various embodiments in the figures and as described illustrate a combination of various features that can be used in fluidic devices in accordance with aspects of the present disclosure, other embodiments of fluidic devices can utilize the various features independently or in any combination. The embodiments shown in the figures are therefore illustrative and should not be considered as limiting.

1.-56. (canceled)

57. A fluidic device for conducting a biological assay, the fluidic device comprising:
a fluidic component defining a fluidic network comprising a plurality of chambers; and
a surface feature located proximate at least one chamber of the plurality of chambers, the surface feature configured to manipulate light transmitted toward the surface feature in differing patterns based on a substance in the at least one chamber of the plurality of chambers covering a location of the surface feature.

58. The fluidic device of claim 57, further comprising a circuit board component configured to align a thermal energy generation element with the at least one chamber of the plurality of chambers, and one or more thermally insulative portions adjacent a perimeter of the at least one chamber of the plurality of chambers.

59. The fluidic device of claim 57, wherein the surface feature is configured to reflect the transmitted light based on a presence or absence of air in the at least one chamber of the plurality of chambers.

60. The fluidic device of claim 57, wherein the surface feature is a first surface feature, and wherein the fluidic device further comprises a second surface feature positioned to intercept light reflected from the first surface feature and reflect the intercepted light in a direction opposite to a direction of the transmitted light toward the first surface feature.

61. The fluidic device of claim 60, wherein the second surface feature is defined by a wall of the fluidic component adjacent and outside a perimeter of the at least one chamber.

62. The fluidic device of claim 60, wherein the first surface feature and the second surface feature define an angled recess in an interior wall surface of the portion of the fluidic component defining the at least one chamber.

63. The fluidic device of claim 57, wherein the surface feature is configured to direct the transmitted light into the at least one chamber based on a liquid in the at least one chamber covering a location of the surface feature.

64. The fluidic device of claim 58, wherein the one or more thermally insulative portions comprise air gaps in the fluidic component.

65. The fluidic device of claim 58, wherein the fluidic component has a longitudinal dimension and a lateral dimension, and a thickness dimension perpendicular to the longitudinal and lateral dimensions, and wherein the one or more thermally insulative portions comprise air gaps are cored out portions through the thickness dimension of the fluidic component.

66. The fluidic device of claim 58, wherein the one or more thermally insulative portions comprise a material having a lower thermal conductivity than a material of the fluidic component defining the fluidic network.

67. The fluidic device of claim 58, wherein the one or more thermally insulative portions are regions of the fluidic component of reduced thickness relative to the thickness of the fluidic component.

68. The fluidic device of claim 57, wherein the plurality of chambers comprises:
a reaction chamber; and
a detection chamber including a lateral flow substrate, the lateral flow substrate comprising:
at least one capture region including one or more reagents configured to react with a labeled target analyte to provide a detectable signal in response to the reaction; and
a fiducial mark present at the at least one capture region, wherein the fiducial mark is configured for detection calibration.

69. The fluidic device of any of claim 68, wherein the fiducial mark is configured to disappear upon an aqueous substance contacting the fiducial mark.

70. The fluidic device of any of claim 68, wherein the fiducial mark is configured to be sensed by an imaging device.

71. The fluidic device of claim 68, wherein the reaction chamber has a pair of opposing longitudinal sides and the one or more thermally insulative portions comprise two portions respectively disposed adjacent each opposing longitudinal side of the pair of opposing longitudinal sides.

72. The fluidic device of claim 68, wherein a perimeter of the reaction chamber comprises two opposing longitudinal sides and two opposing lateral sides, and wherein the one or more thermally insulative portions comprise at least three portions respectively disposed adjacent differing sides of the perimeter.

73. The fluidic device of claim 72, wherein the one or more thermally insulative portions comprise four portions respectively disposed adjacent each of the two opposing longitudinal sides and the two opposing lateral sides.

74. The fluidic device of claim 58, wherein the circuit board component is configured to align a thermal energy generation element with a heat-labile material.

75. The fluidic device of claim 58, wherein the circuit board component is a flexible circuit board.

76. The fluidic device of claim 57, wherein the fluidic network further comprises one or more vent pockets in fluidic communication with one or more of the plurality of chambers, and a heat labile material sealing the one or more vent pockets.
